(19) United States
(12) Patent Application Publication
(10) Pub. No.: US 2022/0269120 A1
(43) Pub. Date: Aug. 25, 2022

(54) DEVICES INCLUDING BIREFRINGENT MEDIUM HAVING CHIRALITY

(71) Applicant: Facebook Technologies, LLC, Menlo Park, CA (US)

(72) Inventors: Hyunmin SONG, Redmond, WA (US); Chia-Hsuan TAI, San Jose, CA (US); Junren WANG, Kirkland, WA (US)

(21) Appl. No.: 17/541,228

(22) Filed: Dec. 2, 2021

Related U.S. Application Data
(60) Provisional application No. 63/152,334, filed on Feb. 22, 2021.
(60) Provisional application No. 63/194,993, filed on May 29, 2021.

(51) Int. Cl. G02F 1/139; G02B 5/30; G02B 27/28; G02F 1/01

(52) U.S. Cl. CPC G02F 1/1393; G02B 5/3016; G02B 27/288; G02F 1/0136; G02F 2202/04; G02F 2202/06

(57) ABSTRACT

A device is provided. The device includes a first birefringent film including a calamitic liquid crystal (“LC”) material configured with a first helical structure. The device also includes a second birefringent film stacked with the first birefringent film and including a discotic LC material configured with a second helical structure.

### CROSS REFERENCE TO RELATED APPLICATIONS

This application claims the benefit of priority to U.S. Provisional Application No. 63/152,334, filed on Feb. 22, 2021, and U.S. Provisional Application No. 63/194,993, filed on May 29, 2021. The contents of the above-mentioned applications are incorporated herein by reference in their entirety.

### TECHNICAL FIELD

The present disclosure relates generally to optical devices and, more specifically, to devices including a birefringent medium having a chirality.

### BACKGROUND

Birefringent media having a chirality may be used in various optical elements or devices. One type of birefringent media having a chirality is cholesteric liquid crystals (“CLCs”), also known as chiral nematic liquid crystals. CLCs have been used in optical elements to reflect or transmit an incident light depending on the handedness of the incident light. For example, CLCs may be configured to substantially reflect a polarized light having a same handedness as that of a helical twist structure of the CLCs, and substantially transmit a polarized light having a handedness opposite to that of the helical twist structure of the CLCs. Due to the handedness selectivity of the CLCs, a CLC layer (or film, plate, etc.) or a CLC layer stack may function as a circular reflective polarizer. Circular reflective polarizers based on CLCs may function over a broad bandwidth or a narrow bandwidth, and may be used as multifunctional optical components, such as polarization conversion components, brightness enhancement components, or optical path-folding components.

### SUMMARY OF THE DISCLOSURE

Consistent with an aspect of the present disclosure, a device is provided. The device includes a first birefringent film including a calamitic liquid crystal (“LC”) material configured with a first helical structure. The device also includes a second birefringent film stacked with the first birefringent film and including a discotic LC material configured with a second helical structure.

Consistent with another aspect of the present disclosure, a device is provided. The device includes an optical film including a birefringent medium having a chirality, the birefringent medium including a host material and dyes doped into the host material. The dyes are configured to absorb a first circularly polarized light having a predetermined handedness more than a second circularly polarized light having a handedness opposite to the predetermined handedness.

Consistent with another aspect of the present disclosure, a lens assembly is provided. The lens assembly includes a first optical element including a mirror configured to transmit a first portion of a first circularly polarized light having a first handedness. The lens assembly also includes a second optical element including a reflective polarizer configured to reflect the first portion of the first circularly polarized light as a second circularly polarized light having the first handedness back toward the mirror. The reflective polarizer includes a first birefringent film including a calamitic liquid crystal (“LC”) material, and a second birefringent film stacked with the first birefringent film and including a discotic LC material. At least one of the first optical element or the second optical element includes a lens.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a diagram of orientations of liquid crystal (“LC”) molecules in a calamitic cholesteric liquid crystal (“CLC”) film, according to an embodiment of the present disclosure;

FIG. 1B schematically illustrates a diagram of orientations of LC molecules in a discotic CLC film, according to an embodiment of the present disclosure;

FIG. 1C illustrates polarization selective reflection of a CLC film, according to an embodiment of the present disclosure;

FIG. 2A schematically illustrates a diagram of an LC device, according to an embodiment of the present disclosure;

FIG. 2B schematically illustrates a diagram of an LC device, according to an embodiment of the present disclosure;

FIG. 2C schematically illustrates a diagram of an LC device, according to an embodiment of the present disclosure;

FIG. 3A schematically illustrates a diagram of a calamitic CLC layer, according to an embodiment of the present disclosure;

FIG. 3B schematically illustrates a diagram of a calamitic CLC layer, according to an embodiment of the present disclosure;

FIG. 3C schematically illustrates a diagram of a discotic CLC layer, according to an embodiment of the present disclosure;

FIG. 3D schematically illustrates a diagram of a discotic CLC layer, according to an embodiment of the present disclosure;

FIG. 4A schematically illustrates a diagram of an LC device, according to an embodiment of the present disclosure;

FIG. 4B schematically illustrates a diagram of an LC device, according to an embodiment of the present disclosure;

FIG. 5A schematically illustrates a diagram of a pancake lens assembly, according to an embodiment of the present disclosure;

FIG. 5B schematically illustrates a cross-sectional view of an optical path of the pancake lens assembly shown in FIG. 5A, according to an embodiment of the present disclosure;

FIG. 6A illustrates a schematic diagram of a near-eye display (“NED”), according to an embodiment of the present disclosure;

FIG. 6B illustrates a schematic cross sectional view of half of the NED shown in FIG. 6A, according to an embodiment of the present disclosure;

FIG. 7A schematically illustrates a diagram of an LC device operating at a voltage-off state, according to an embodiment of the present disclosure;

FIG. 7B schematically illustrates a diagram of the LC device shown in FIG. 7A operating at a voltage-on state, according to an embodiment of the present disclosure;

FIG. 8A schematically illustrates a diagram of an LC device operating at a voltage-off state, according to an embodiment of the present disclosure;

FIG. 8B schematically illustrates a diagram of the LC device shown in FIG. 8A operating at a voltage-on state, according to an embodiment of the present disclosure;

FIG. 9A schematically illustrates a diagram of an LC device operating at a voltage-off state, according to an embodiment of the present disclosure;

FIG. 9B schematically illustrates a diagram of the LC device shown in FIG. 9A operating at a voltage-on state, according to an embodiment of the present disclosure; and

FIG. 10 schematically illustrates a schematic diagram of a light guide display assembly, according to another embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or orientation within a surface plane, an “out-of-plane” direction or orientation may refer to a thickness direction or orientation perpendicular to the surface plane, or a direction or orientation that is not parallel with the surface plane.

The term “orthogonal” as used in “orthogonal polarizations” or the term “orthogonally” as used in “orthogonally polarized” means that an inner product of two vectors representing the two polarizations is substantially zero. For example, two lights with orthogonal polarizations or two orthogonally polarized lights may be two linearly polarized lights with polarizations in two orthogonal directions (e.g., an x-axis direction and a y-axis direction in a Cartesian coordinate system) or two circularly polarized lights with opposite handednesses (e.g., a left-handed circularly polarized light and a right-handed circularly polarized light).

The term “substantially” or “primarily” used to modify an optical response action, such as transmit, reflect, diffract, block or the like that describes processing of a light means that a majority portion, including all, of a light is transmitted, reflected, diffracted, or blocked, etc. The majority portion may be a predetermined percentage (greater than 50%) of the entire light, such as 100%, 95%, 90%, 85%, 80%, etc., which may be determined based on specific application needs. The term “strongly” may have similar meaning as the term “substantially” or “primarily”, which indicates that greater than 50% of the light is processed by the optical response action modified by the term “strongly.” The term “weakly” indicates that less than 50% of the light is processed by the optical response action modified by the term “weakly.” For example, the term “strongly absorb” may indicate that an optical element absorbs greater than 50% of the light, and the term “weakly absorb” may indicate that the optical element absorbs less than 50% of the light. In the present disclosure, for simplicity, the term “substantially” may not be present to modify an optical response action whenever an optical response action is described. In such situations, a person having ordinary skill in the art understands that the optical response action means a substantial optical response action, as if the term “substantially” were present to modify the optical response action.

The present disclosure provides various liquid crystal (“LC”) devices based on a birefringent medium having a chirality. In some embodiments, the birefringent medium may include a host birefringent material, e.g., a nematic LCs. In some embodiments, the birefringent medium may also include chiral dopants, and the chirality of the birefringent medium may be introduced by the chiral dopants doped into the host birefringent material. In some embodiments, the chirality of the birefringent medium may be a property of the birefringent medium itself, such as an intrinsic molecular chirality of the host birefringent material. For example, the host birefringent material may include chiral optically anisotropic molecules, or include optically anisotropic molecules having one or more chiral functional groups. In some embodiments, the birefringent medium with a chirality may include twist-bend nematic LCs (or LCs in a twist-bend nematic phase), in which the LC directors may exhibit periodic twist and bend deformations forming a conical helix with doubly degenerate domains having opposite handednesses. The LC directors of the twist-bend nematic LCs may be tilted with respect to the helical axis. Thus, the twist-bend nematic phase may be considered as the generalized case of the conventional nematic phase in which the LC directors are orthogonal with respect to the helical axis.

In some embodiments, the present disclosure provides an LC device functioning as a circular reflective polarizer. The device may include a first birefringent film and a second birefringent film stacked with the first birefringent film. The first birefringent film may include a calamitic liquid crystal (“LC”) material configured with a first helical structure. The second birefringent film may include a discotic LC material configured with a second helical structure. In some embodiments, at least one of the first birefringent film or the second birefringent film may be a liquid crystal polymer film. In some embodiments, both of the first helical structure and the second helical structure may have a constant helix pitch. In some embodiments, both of the first helical structure and the second helical structure may have a varying helix pitch. In some embodiments, one of the first helical structure and the second helical structure may have a constant helix pitch, and the other one of first helical structure and the second helical structure may have a varying helix pitch.

In some embodiments, for an oblique incident light, the first birefringent film may be configured to provide a first phase shift, and the second birefringent film may be configured to provide a second phase shift. The first phase shift may at least partially cancel out the second phase shift. In some embodiments, the first helical structure and the second helical structure may have the same handedness. In some embodiments, the handedness of the first helical structure and the second helical structure may be a first handedness. The device may be configured to reflect a first circularly polarized light having the first handedness as a second circularly polarized light having the first handedness, and transmit a third circularly polarized light having a second handedness that is opposite to the first handedness as a fourth circularly polarized light having the second handedness.

In some embodiments, the present disclosure also provides an LC device functioning as an absorptive circular polarizer. The LC device may include an optical film. The optical film may include a birefringent medium having a chirality, and including a host material and dyes doped into the host material. The dyes may be configured to absorb a first circularly polarized light having a predetermined handedness more than a second circularly polarized light having a handedness opposite to the predetermined handedness. In some embodiments, the optical film may be configured to block, via absorption, the first circularly polarized light, and transmit or reflect the second circularly polarized light.

In some embodiments, molecules of the dyes may have molecular helices with an induced axial chirality. In some embodiments, the molecular helices of the molecules of the dyes may rotate in a same rotating direction, along a same predetermined direction within a volume of the optical film. In some embodiments, the dyes may function as chiral dopants for introducing the chirality. In some embodiments, molecules of the dyes may form a plurality of supramolecules within a volume of the optical film, and molecular helices of the supramolecules may rotate in a predetermined direction along an axial direction of the optical film.

In some embodiments, the present disclosure also provides a lens assembly. The lens assembly may include a first optical element including a mirror configured to transmit a first portion of a first circularly polarized light having a first handedness. The lens assembly may also include a second optical element including a reflective polarizer configured to reflect the first portion of the first circularly polarized light as a second circularly polarized light having the first handedness back toward the mirror. The reflective polarizer may include a first birefringent film including a calamitic LC material, and a second birefringent film stacked with the first birefringent film and including a discotic LC material. At least one of the first optical element or the second optical element may include a lens.

In some embodiments, the mirror may be further configured to reflect the second circularly polarized light having the first handedness as a third circularly polarized light having a second handedness. The reflective polarizer may be further configured to transmit the third circularly polarized light having the second handedness as a fourth circularly polarized light having the second handedness. In some embodiments, at least one of the first birefringent film or the second birefringent film may be a liquid crystal polymer film. In some embodiments, the calamitic LC material may be configured with a first helical structure having a first helix pitch, the discotic LC material may be configured with a second helical structure having a second helix pitch. At least one of the first helix pitch or the second helix pitch may be a constant helix pitch or a varying helix pitch. In some embodiments, for an oblique incident light, the first birefringent film is configured to provide a first phase shift and the second birefringent film is configured to provide a second phase shift. The first phase shift may at least partially cancel out the second phase shift.

In some embodiments, the reflective polarizer may be a first polarizer, the first optical element may further include a second polarizer. In some embodiments, the mirror may be disposed between the first polarizer and the second polarizer. The second polarizer may include a birefringent medium having a chirality and including a host material and dyes. The dyes may be configured to absorb a circularly polarized light having a second handedness more than a circularly polarized light having the first handedness.

Cholesteric liquid crystals (“CLCs”) are a type of birefringent material with a chirality. CLCs are liquid crystals that exhibit a helical structure and, thus, exhibit chirality, i.e., handedness. CLCs are also known as chiral nematic liquid crystals. For a polarized incident light (e.g., a circularly or elliptically polarized light) having a wavelength within a reflection band of the CLCs, when the handedness of the polarized incident light is the same as the handedness of the helical structure of the CLCs, the CLCs may substantially (or primarily) reflect the polarized incident light. When the handedness of the polarized incident light is different from (e.g., opposite to) the handedness of the helical structure of the CLCs, the CLCs may substantially transmit the polarized incident light. In the following descriptions, for illustrative purposes, CLCs are used as an example of the birefringent material with a chirality. CLC polarizers (e.g., circular absorptive polarizers, circular reflective polarizers) are used as an example of the polarizer based on the birefringent material with a chirality. In some embodiments, polarizers (e.g., absorptive polarizers, reflective polarizers, etc.) may also be configured based on another suitable birefringent material with a chirality, following the same design principles for the CLC polarizers described below.

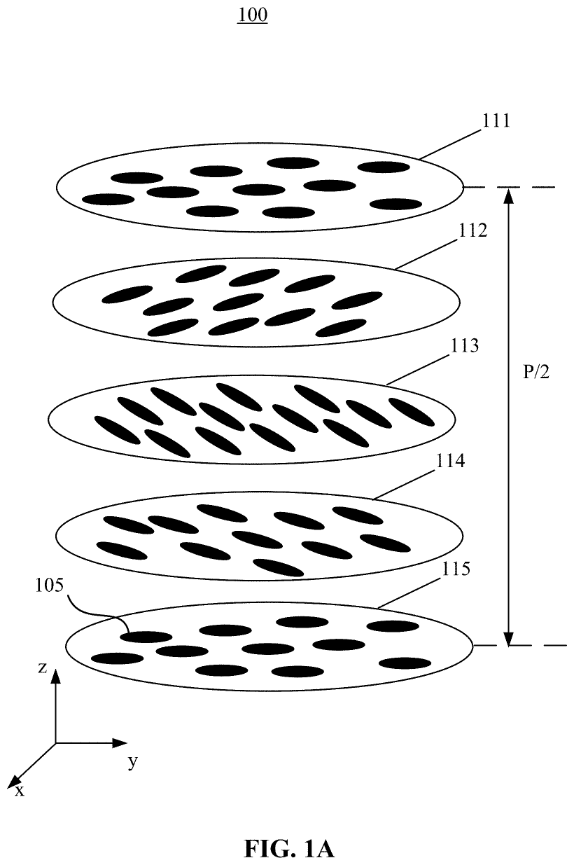

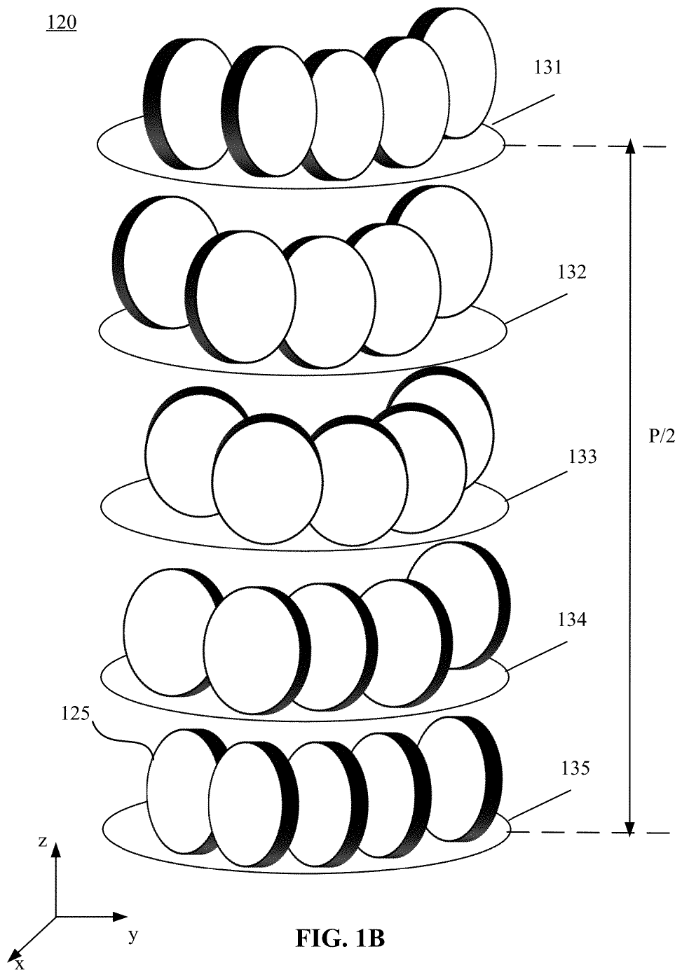

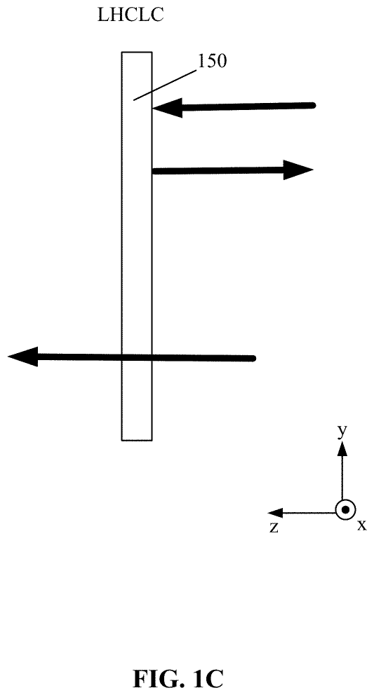

FIG. 1A illustrates a schematic diagram of a CLC film 100 including chiral calamitic (or rod-like, or rod-shaped) nematic LCs or calamitic LCs in a chiral nematic phase. The CLC film 100 may also be referred to as a calamitic (or rod-like, or rod-shaped) CLC film 100. The chiral calamitic nematic LCs may include calamitic (or rod-like, or rod-shaped) LC molecules 105 each having a longitudinal axis (or a length direction) and a lateral axis (or a width direction). The longitudinal axis of the calamitic LC molecule 105 may be referred to as a director of the calamitic LC molecule 105 or an LC director. In the schematic diagram shown in FIG. 1A, the calamitic LC molecules 105 are represented by solid rods. FIG. 1A illustrates a schematic diagram of orientations of directors of the calamitic LC molecules 105 in the calamitic CLC film 100. In the calamitic CLC film 100, the calamitic LC molecules 105 may be organized in multiple layers 111, 112, 113, 114, 115 with no positional ordering among the layers. In an axial direction (e.g., a z-axis direction shown in FIG. 1A) of the calamitic CLC film 100, orientations of the LC directors (e.g., long axes of the calamitic LC molecules 105) may exhibit a rotation in a predetermined direction (e.g., a clockwise direction or a counter-clockwise direction) between layers (e.g., from one layer to another). In the same layer, the orientations of the LC directors may be substantially the same.

FIG. 1B illustrates a schematic diagram of a CLC film 120 including chiral discotic (or disc-like, or disc-shaped) nematic LCs or discotic LCs in a chiral nematic phase. The CLC film 120 may also be referred to as a discotic (or disc-like, or disc-shaped) CLC film 120. The chiral discotic nematic LCs may include discotic (or disc-like, or disc-shaped) LC molecules 125 that may include a flat or substantially flat central aromatic disc-shaped core, substituted by more than three flexible aliphatic carbon chains. In the schematic diagram shown in FIG. 1B, the discotic LC molecules 125 are represented by disks. The discotic LC molecules 125 may have a short molecular axis or a disc normal. The discotic LC molecules 125 may possess full translational and rotational freedom around their short molecular axes (or the disc normal). The short molecular axis (disc normal) of the discotic LC molecules 125 may be referred to as a director of the discotic LC molecules 125 or an LC director.

FIG. 1B illustrates a schematic diagram of orientations of directors of discotic LC molecules 125 in the discotic CLC film 120. In the discotic CLC film 120, the discotic LC molecules 125 may be organized in multiple layers 131, 132, 133, 134, 135 with no positional ordering among the layers. The orientations of the LC directors (e.g., short axes or disc normals of the discotic LC molecules 125) in an axial direction (e.g., a z-axis direction shown in FIG. 1B) of the discotic CLC film 120 may exhibit a rotation in a predetermined direction (e.g., a clockwise direction or a counter-clockwise direction) between layers. In the same layer, the orientations of the LC directors may be substantially the same.

Referring to FIGS. 1A and 1B, in some embodiments, in the volume of the calamitic CLC film 100 or discotic CLC film 120, the variation of the LC directors along the axial direction (e.g., the z-axis direction) between the layers may be periodic. The periodicity of the variation of the LC directors, i.e., an axial length or distance over which the orientations of the LC directors change by 360°, is referred to as a helix pitch P. In some embodiments, the variation of the LC directors may repeat at every half pitch (P/2), as the LC directors at 0° and ±180° may be equivalent. Thus, in the volume of the calamitic CLC film 100 or discotic CLC film 120, the calamitic LC molecules 105 or the discotic LC molecules 125 may exhibit a helical structure having a predetermined handedness. For illustrative purposes, FIG. 1A shows the variation of the LC directors in a half pitch (P/2), and the calamitic LC molecules 105 are organized in five layers 111, 112, 113, 114, 115 to show the variation of the LC directors in the half pitch (P/2). FIG. 1B shows the variation of the LC directors in a half pitch (P/2), and the discotic LC molecules 125 are organized in five layers 131, 132, 133, 134, 135 to show the variation of the LC directors in the half pitch (P/2).

The helix pitch P may determine, in part, a reflection band of the calamitic CLC film 100 or discotic CLC film 120, i.e., a band of incidence wavelengths of a light that may be substantially reflected by the CLC film 100 or 120 via Bragg reflection. For example, when the helix pitch P is of the same order as the wavelengths of visible lights, the calamitic CLC film 100 or the discotic CLC film 120 may be configured to substantially reflect a polarized visible light having a predetermined handedness, and substantially transmit a polarized visible light having a handedness opposite to the predetermined handedness. The reflection band of the calamitic CLC film 100 or the discotic CLC film 120 may be centered at a wavelength λ₀=n*P, where n may be an average refractive index of the LCs in the calamitic CLC film 100 or the discotic CLC film 120, and n may be calculated as n=(nₑ+nₒ)/2. Here, nₑ and nₒ represent the extraordinary and ordinary reflective indices of the LCs, respectively, and P represents the helix pitch. A reflection bandwidth Δλ, of the calamitic CLC film 100 or the discotic CLC film 120 may be calculated as Δλ=Δn*P, which may be proportional to the birefringence Δn of the LCs, where Δn=nₑ−nₒ.

FIG. 1C illustrates polarization selective reflectivity of a CLC film 150. The CLC film 150 may be an embodiment of the calamitic CLC film 100 shown in FIG. 1A or the discotic CLC film 120 shown in FIG. 1B. The CLC film 150 may function as a polarizing film (or a circular reflective polarizer). For a polarized incident light (e.g., a circularly or elliptically polarized light) having an incidence wavelength within the reflection band of the CLC film 150, when the handedness of the polarized incident light is the same as the handedness of the helical structure of the CLC film 150, the CLC film 150 may substantially reflect the polarized incident light. When the handedness of the polarized incident light is different from (e.g., opposite to) the handedness of the helical structure of the CLC film 150, the CLC film 150 may substantially transmit the polarized incident light.

For example, as shown in FIG. 1B, the CLC film 150 may exhibit a high reflectance for a left-handed circularly polarized (“LHCP”) incident light and a high transmittance for a right-handed circularly polarized (“RHCP”) incident light. That is, for a light having an incidence wavelength within the reflection band of the CLC film 150, the CLC film 150 may substantially reflect the LHCP light (or the LHCP component), and substantially transmit the RHCP light (or the RHCP component). Such a CLC film 150 may be referred to as a left-handed CLC film. A right-handed CLC film may substantially reflect the RHCP light, and substantially transmit the LHCP light. For an input light including an RHCP component and an LHCP component, each component may be selectively reflected or transmitted depending on the handedness of the component and the handedness of the helical structure of the CLC film 150. In some embodiments, for both of the reflected light and the transmitted light of the CLC film 150, their polarization states may remain unchanged. In some embodiments, due to the waveplate effect of the CLC film 150, the polarization states of at least one of the reflected light or the transmitted light may be changed, which may result in a light leakage. When the incidence wavelength is outside of the reflection band of the CLC film 150, a circularly polarized light may be transmitted by the CLC film 150 regardless of the handedness.

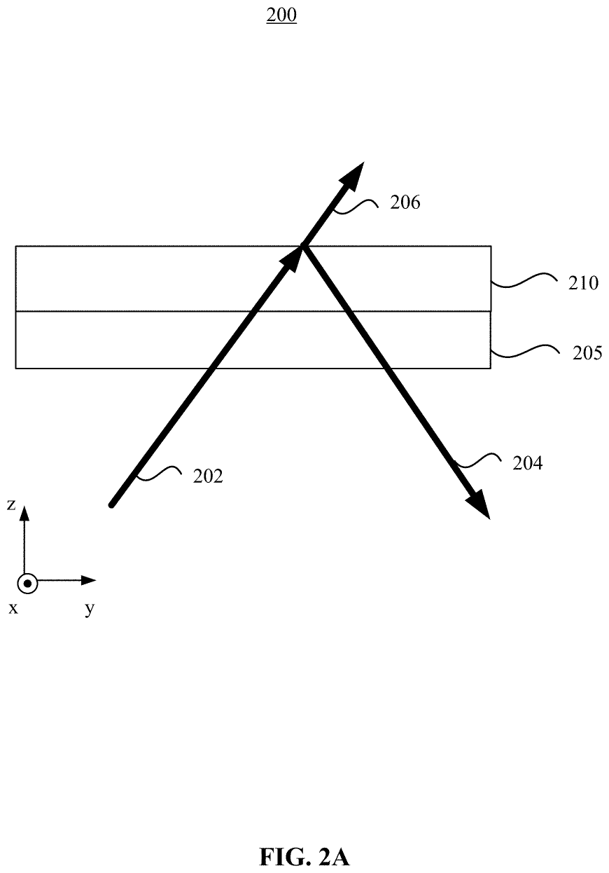

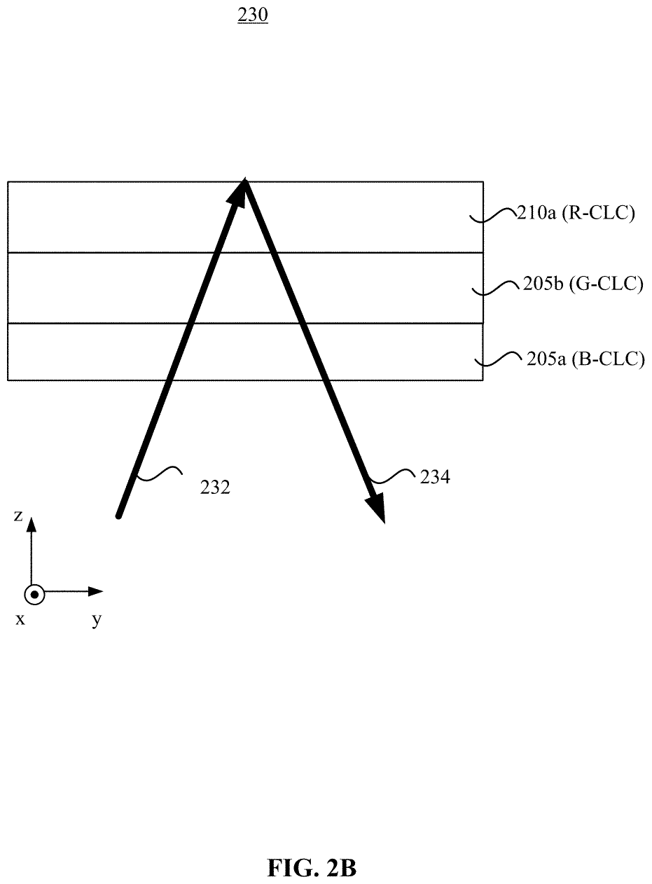

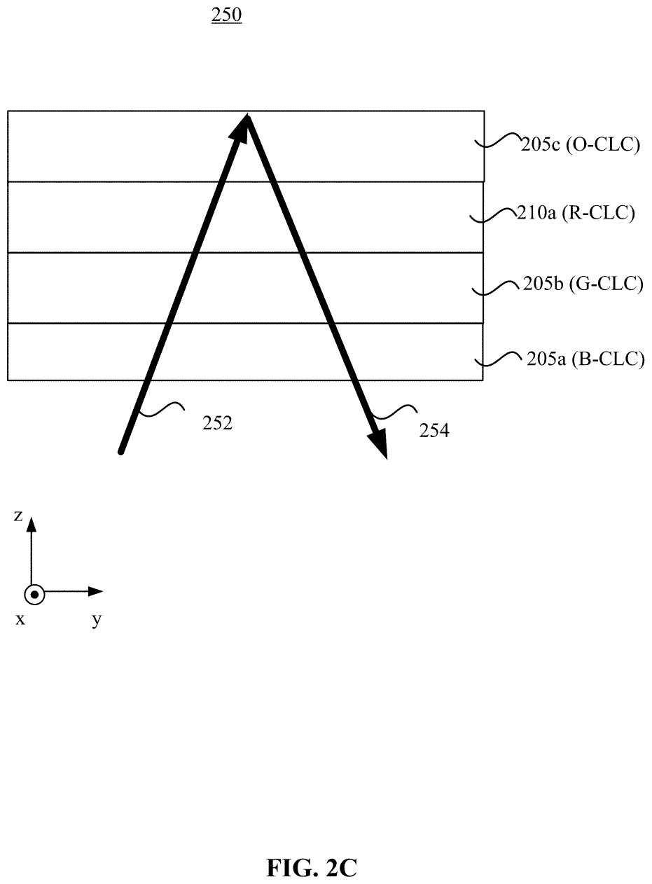

FIG. 2A schematically illustrates a y-z sectional view of an LC device 200, according to an embodiment of the present disclosure. The LC device 200 may function as a circular reflective polarizer configured to selectively reflect or transmit a circularly polarized light with a low light leakage (e.g., lower than 5%, 2%, 1%, etc.). As shown in FIG. 2A, the LC device 200 may include a stack of CLC layers or films. The LC device 200 may also be referred to as a CLC reflective polarizer 200. The stack of CLC layers may include one or more calamitic CLC layers 205, and at least one discotic (or disc-like, or disc-shaped) CLC layer 210. In some embodiments, at least one (e.g., each) of the CLC layers may include passive LCs with LC directors not reorientable by an external field, e.g., the electric field provided by a power source. In some embodiments, at least one (e.g., each) of the CLC layers may include a liquid crystal polymer (“LCP”) layer. In some embodiments, the LCP layer may include polymerized (or cross-linked) LCs, polymer-stabilized LCs, photo-reactive LC polymers, or any combination thereof. The LCs may include nematic LCs, twist-bend LCs, chiral nematic LCs, smectic LCs, or any combination thereof. In some embodiments, at least one (e.g., each) of the CLC layers may include active LCs with LC directors reorientable by an external field, e.g., the electric field provided by a power source, such that the optical properties (e.g., reflection and/or transmission, reflection band) of the CLC layer may be adjustable. For example, when the external electric field is lower than a first predetermined threshold, the CLC layer may have a helical twist structure, functioning as a polarizing film configured to selectively reflect or transmit a circularly polarized light having a predetermined wavelength range, depending on the handedness of the circularly polarized light. When the external electric field is changed, the reflection band of the of the CLC layer may be changed, accordingly. When the external electric field is higher than a second predetermined threshold, the active LCs may be aligned along in a direction of the electric field, and the helical twist structure may be untwisted. As a result, the CLC layer may transmit a circularly polarized light, independent of the handedness of the light.

For discussion purposes, FIG. 2A shows that the CLC reflective polarizer 200 includes one calamitic CLC layer 205 and one discotic CLC layer 210 stacked together. The number of calamitic CLC layer and discotic CLC layer is not limited to one, and any number can be used, such as two, three, four, etc. In addition, the number of calamitic CLC layers and the number of discotic CLC layers may or may not be the same number. In some embodiments, at least one (e.g., each) of the calamitic CLC layer 205 or the discotic CLC layer 210 may be an LCP layer. In some embodiments, at least one (e.g., each) of the calamitic CLC layer 205 or the discotic CLC layer 210 may be an active LC layer including active LCs.

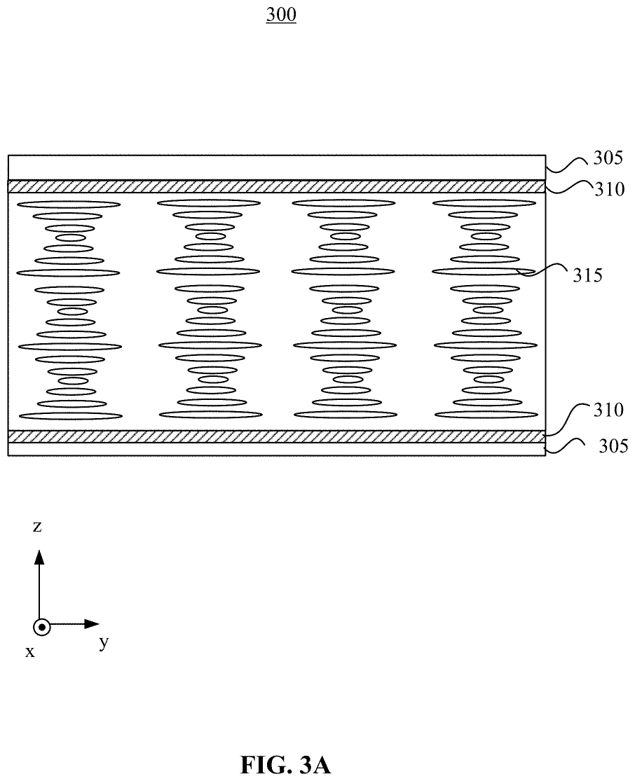

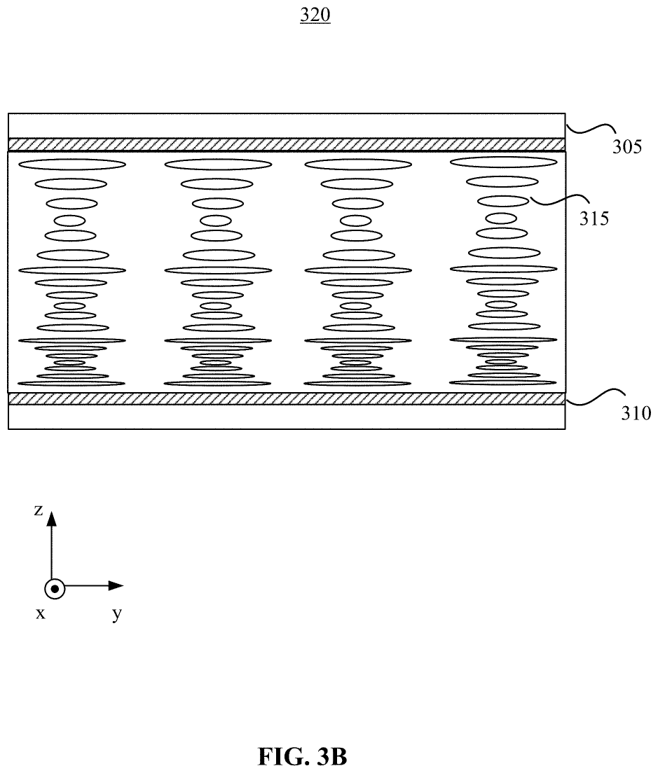

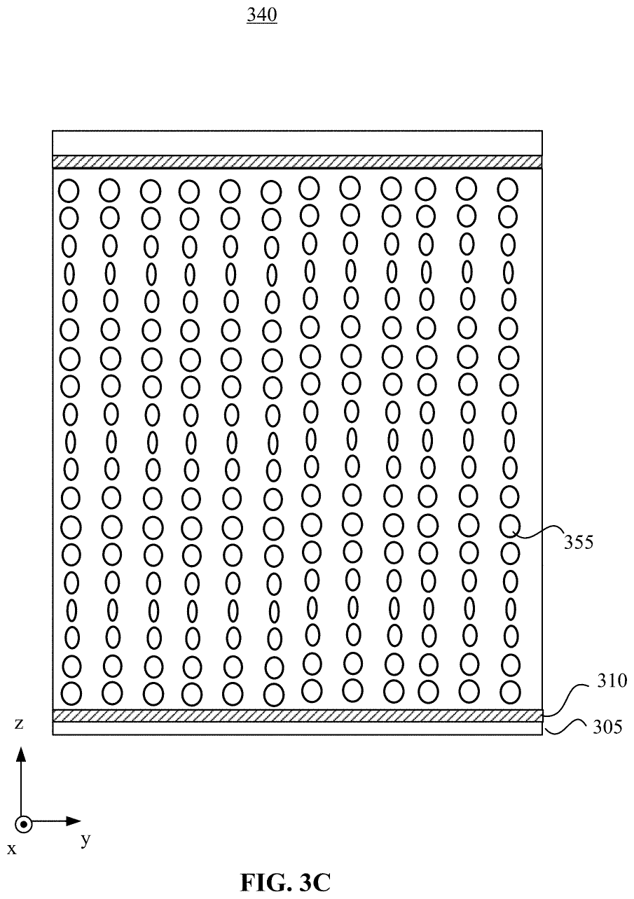

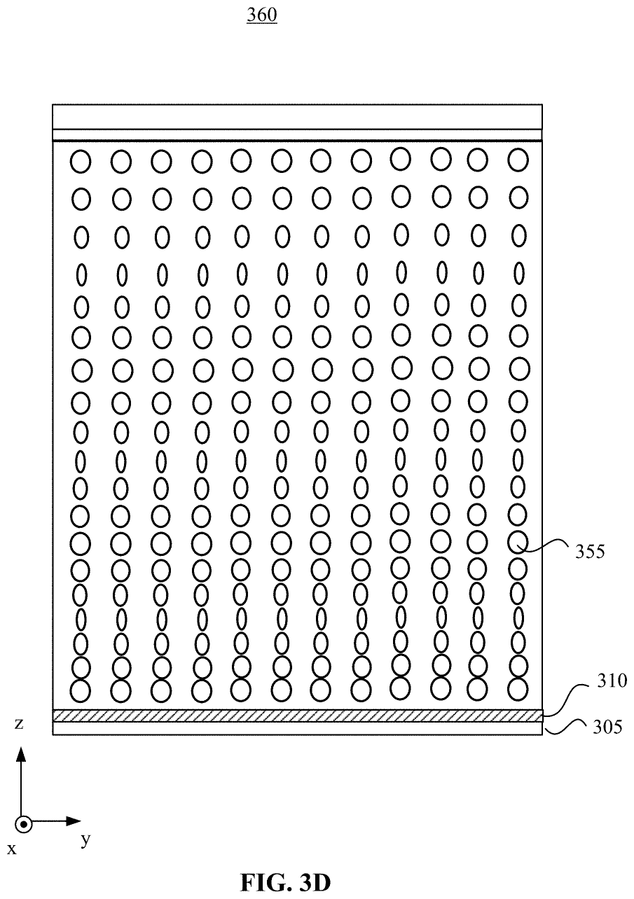

FIG. 3A schematically illustrates a y-z sectional view of a CLC layer or film 300, according to an embodiment of the present disclosure. The CLC layer 300 may be an embodiment of the calamitic CLC layer 205 shown in FIG. 2A. As shown in FIG. 3A, the CLC layer 300 may include calamitic nematic LCs 315 arranged in a helical structure of a constant helix pitch (e.g., a same, fixed helix pitch is repeated in the z-axis or thickness direction). Such a CLC layer 300 may also be referred to as a single-pitch CLC layer, e.g., a single-pitch calamitic CLC layer. In some embodiments, an axis of the helix may be normal (e.g., perpendicular) to the surface of the CLC layer 300. In some embodiments, the constant helix pitch configuration may result in a narrow reflection band for the CLC layer 300. For example, the CLC layer 300 may be configured to have a reflection band covering a narrowband wavelength range, e.g., a 30 nm bandwidth. The CLC layer 300 may substantially reflect a narrowband circularly polarized light having a handedness that is the same as the handedness of the helical structure and having a wavelength range within the reflection band. The CLC layer 300 may substantially transmit a narrowband circularly polarized light having a handedness that is opposite to the handedness of the helical structure and having a wavelength range within the reflection band.

In some embodiments, the calamitic nematic LCs 315 may form an LCP layer. In some embodiments, the calamitic nematic LCs 315 may include active LCs. In some embodiments, the CLC layer 300 may further include one or more substrates 305 for support and protective purposes. Two substrates 305 are shown in FIG. 3A for illustrative purposes. The number of substrates is not limited to two and may be any suitable number. In some embodiments, the substrates 305 may be optically transparent in one or more wavelength bands, e.g., the visible band (about 380 nm to about 700 nm), some or all of the infrared (“IR”) band (e.g., about 700 nm to about 1 mm, or any portion thereof), and/or the ultraviolet (“UV”) band, etc. In some embodiments, the substrate 305 may include a glass, a plastic, a sapphire, etc. The substrate 305 may be rigid, semi-rigid, flexible, or semi-flexible. The substrate 305 may include a flat surface or a curved surface, on which the different layers or films may be formed. In some embodiments, the substrate 305 may be a part of another optical element or device (e.g., another opto-electrical element or device). For example, the substrate 305 may be a solid optical lens, a part of a solid optical lens, or a light guide (or waveguide), etc. In some embodiments, the substrate 305 may be used in the fabrication, storage, or transportation of the CLC layer 300. In some embodiments, the substrate 305 may be detachable or removable after the CLC layer 300 is fabricated or transported to another place or device. In some embodiments, the substrate 305 may not be separated from the CLC layer 300, and may be an integral part of the CLC layer 300.

In some embodiments, at least one of the substrates 305 may be provided with an alignment layer 310, which may be configured to provide an initial alignment of the calamitic nematic LCs 315. In the embodiment shown in FIG. 3A, two alignment layers 310 are provided for illustrative purposes, with each alignment layer 310 being coupled (e.g., stacked) with each substrate 305. The number of the alignment layers 310 is not limited to two, and may be any suitable number. The number of the alignment layers 310 may or may not be the same as the number of the substrates 305. In some embodiments, the alignment layer 310 may provide anti-parallel homogeneous alignments of the calamitic nematic LCs 315. In some embodiments, the alignment layer 310 may be used in the fabrication, storage, or transportation of the CLC layer 300. In some embodiments, the alignment layer 310 may be detachable or removable after the CLC layer 300 is fabricated or transported to another place or device. In some embodiments, the alignment layer 310 may not be separated from the CLC layer 300, and may be an integral part of the CLC layer 300.

FIG. 3B schematically illustrates a y-z sectional view of a CLC layer or film 320, according to an embodiment of the present disclosure. The CLC layer 320 may be an embodiment of the calamitic CLC layer 205 shown in FIG. 2A. The CLC layer 320 may include elements that are similar to those included in the CLC layer 300 shown in FIG. 3A. Descriptions of the similar elements may refer to the above descriptions rendered in connection with FIG. 3A. As shown in FIG. 3B, the CLC layer 320 may include calamitic nematic LCs 315, the alignment layers 310, and the substates 305. In some embodiments, the alignment layers 310 and/or the substates 305 may be omitted, as described above in connection with FIG. 3A. In some embodiments, the calamitic nematic LCs 320 may form an LCP layer. In some embodiments, the calamitic nematic LCs 320 may include active LCs.

The calamitic nematic LCs 315 may be arranged in a helical structure of a varying (e.g., non-constant) helix pitch (e.g., a gradient helix pitch). Such a CLC layer 320 may also be referred to as a varying-pitch CLC layer, e.g., a varying-pitch calamitic CLC layer. In some embodiments, the varying helix pitch configuration may result in a broad reflection band for the CLC layer 320. In some embodiments, the helix pitch may gradually increase or decrease in a predetermined direction (e.g., in a thickness direction of the CLC layer 320). For illustrative purposes, in the embodiment shown in FIG. 3B, the varying helix pitch is shown as gradually increasing along the thickness direction of the CLC layer 320, e.g., along the +z-axis direction as shown in FIG. 3B. For example, the CLC layer 320 may be configured to have a reflection band covering a visible wavelength range, e.g., a 320 nm bandwidth. The CLC layer 320 may substantially reflect a broadband circularly polarized light having a handedness that is the same as the handedness of the helical structure and having a wavelength range within the reflection band. The CLC layer 320 may substantially transmit a broadband circularly polarized light having a handedness that is opposite to the handedness of the helical structure and having a wavelength range within the reflection band.

In some embodiments, a broad reflection band may also be achieved by a plurality of single-pitch CLC layers (e.g., similar to the single-pitch CLC layer 300 shown in FIG. 3A) stacked together. Each calamitic CLC layer may include calamitic nematic LCs 315 arranged in a helical structure of a constant helix pitch. The helix pitches may vary from layer to layer (e.g., at least two helix pitches of the plurality of single-pitch CLC layers may be different). The CLC layers may have narrow reflection bandwidths and may be optically coupled to corresponding narrowband (e.g., 30 nm bandwidth) light sources emitting lights in different colors (e.g., different wavelengths). In some embodiments, the reflection bands of the CLC layers may not overlap with each other. In some embodiments, the reflection bands of the CLC layers may overlap (e.g., slightly overlap) with each other, such that an overall reflection band may be continuous and broad.

FIG. 3C schematically illustrates a y-z sectional view of a CLC layer or film 340, according to an embodiment of the present disclosure. The CLC layer 340 may be an embodiment of the discotic CLC layer 210 shown in FIG. 2A. The CLC layer 340 may include elements that are similar to those included in the CLC layer 300 shown in FIG. 3A, or the CLC layer 320 shown in FIG. 3B. Descriptions of the similar elements may refer to the above descriptions rendered in connection with FIG. 3A or FIG. 3B. As shown in FIG. 3C, the CLC layer 340 may include discotic (or disc-like, disc-shaped) nematic LCs 355, the alignment layers 310, and the substates 305. In some embodiments, the discotic nematic LCs 355 may form an LCP layer. In some embodiments, the alignment layers 310 and/or the substates 305 may be omitted. In some embodiments, the discotic nematic LCs 355 may include active LCs.

As shown in FIG. 3C, the discotic nematic LCs 355 may be arranged in a helical structure of a constant helix pitch (e.g., a same, fixed helix pitch may be repeated in the z-axis or thickness direction). Such a CLC layer 340 may also be referred to as a single-pitch CLC layer, e.g., a single-pitch discotic CLC layer. In some embodiments, an axis of the helix may be normal (e.g., perpendicular) to the surface of the CLC layer 340. In some embodiments, the constant helix pitch configuration may result in a narrow reflection band for the CLC layer 340. For example, the CLC layer 340 may be configured to have a reflection band covering a narrowband wavelength range, e.g., 30 nm bandwidth. The CLC layer 340 may substantially reflect a narrowband circularly polarized light having a handedness that is the same as the handedness of the helical structure and having a wavelength range within the reflection band. The CLC layer 340 may substantially transmit a narrowband circularly polarized light having a handedness that is opposite to the handedness of the helical structure and having a wavelength range within the reflection band.

FIG. 3D schematically illustrates a y-z sectional view of a CLC layer or film 360, according to an embodiment of the present disclosure. The CLC layer 360 may be an embodiment of the discotic CLC layer 210 shown in FIG. 2A. The CLC layer 360 may include elements that are similar to those included in the CLC layer 300 shown in FIG. 3A, the CLC layer 320 shown in FIG. 3B, or the CLC layer 340 shown in FIG. 3C. Descriptions of the similar elements may refer to the above descriptions rendered in connection with FIG. 3A, FIG. 3B, or FIG. 3C.

As shown in FIG. 3D, the CLC layer 360 may include discotic (or disc-like, disc-shaped) nematic LCs 355, the alignment layers 310, and the substates 305. In some embodiments, the discotic nematic LCs 355 may form an LCP layer. In some embodiments, the alignment layers 310 and/or the substates 305 may be omitted. In some embodiments, the discotic nematic LCs 355 may include active LCs. The discotic nematic LCs 355 may be arranged in a helical structure of a varying (e.g., non-constant) helix pitch (e.g., a gradient helix pitch). Such a CLC layer 360 may also be referred to as a varying-pitch CLC layer, e.g., a varying-pitch discotic CLC layer. In some embodiments, the vary helix pitch configuration may result in a broad reflection band for the CLC layer 360. In some embodiments, the helix pitch may gradually increase or decrease in a predetermined direction (e.g., in a thickness direction of the CLC layer 360). For illustrative purposes, in the embodiment shown in FIG. 3D, the varying helix pitch is shown as gradually increasing along the thickness direction of the CLC layer 360, e.g., along the +z-axis direction as shown in FIG. 3D. For example, the CLC layer 360 may be configured to have a reflection band covering a visible wavelength range, e.g., a 360 nm bandwidth. The CLC layer 360 may substantially reflect a broadband circularly polarized light having a handedness that is the same as the handedness of the helical structure and having a wavelength range within the reflection band. The CLC layer 360 may substantially transmit a broadband circularly polarized light having a handedness that is opposite to the handedness of the helical structure and having a wavelength range within the reflection band.

In some embodiments, a broad reflection band may also be achieved by a plurality of single-pitch CLC layers (e.g., similar to the single-pitch CLC layer 340 shown in FIG. 3C) stacked together. Each CLC layer may include discotic nematic LCs 355 arranged in a helical structure of a constant helix pitch. The helix pitches may vary from layer to layer (e.g., at least two helix pitches of the plurality of single-pitch CLC layers may be different). The CLC layers may have narrow reflection bandwidths and may be optically coupled to corresponding narrowband (e.g., a 30 nm bandwidth) light sources emitting lights in different colors (e.g., different wavelengths). In some embodiments, the reflection bands of the CLC layers may not overlap with each other. In some embodiments, the reflection bands of the CLC layers may overlap (e.g., slightly overlap) with each other, such that an overall reflection band may be continuous and broad.

Referring back to FIG. 2A, the calamitic CLC layer 205 may be configured with a single-pitch or a varying pitch, and the discotic CLC layer 210 may be configured with a single-pitch or a varying pitch. The calamitic CLC layer 205 and the discotic CLC layer 210 may be configured with a substantially same reflection band, overlapping reflection bands, or non-overlapping reflection bands. For example, in some embodiments, both of the calamitic CLC layer 205 and the discotic CLC layer 210 may be configured with a single-pitch and a substantially same or overlapping reflection band. The CLC reflective polarizer 200 may function as a narrow band reflective polarizer. In some embodiments, both of the calamitic CLC layer 205 and the discotic CLC layer 210 may be configured with a varying-pitch and a substantially same or overlapping reflection band. The CLC reflective polarizer 200 may function as a broadband reflective polarizer.

Referring to FIG. 2A, FIG. 3A, and FIG. 3B, the calamitic CLC layer 205 (e.g., calamitic CLC layer 300 or 320) may reflect a circularly polarized light having a shorter wavelength as the incidence angle of the light increases. This phenomenon may be referred to as blue shift. In other words, the calamitic CLC layer 205 may exhibit a blue shift in the wavelength of the reflected light. In addition, the calamitic CLC layer 205 (e.g., calamitic CLC layer 300 or 320) may serve or function as a negative C-plate. Due to the waveplate effect of the calamitic CLC layer 205, the calamitic CLC layer 205 may introduce an undesirable phase shift (referred to as a first phase shift) to an angular, off-axis (or obliquely incident) light 202 incident onto the CLC reflective polarizer 200. Thus, the polarization states of at least one of the reflected light or the transmitted light of the calamitic CLC layer 205 may be changed. For example, the polarization states of the reflected light and/or the transmitted light may be changed from a circular polarization to an elliptical polarization. This phenomenon may be referred to as depolarization. Depolarization may result in a light leakage, which may degrade an extinction ratio of the CLC reflective polarizer 200. The light leakage may increase as the incidence angle of the light increases. In addition, when a plurality of single-pitch calamitic CLC layers 205 are stacked to realize a broad reflection band, the depolarization of the transmitted light caused by a calamitic CLC layer may result in a lower reflectivity when the transmitted light is incident onto a subsequent calamitic CLC layer.

Referring to FIG. 2A, FIG. 3C, and FIG. 3D, the discotic CLC layer 210 (e.g., discotic CLC layer 340 or 360) in the CLC reflective polarizer 200 may serve or function as a compensation layer configured to optically compensate for the depolarization of the reflected light and/or the transmitted light caused by the calamitic CLC layer 205. For example, the discotic CLC layer 210 may transform an elliptically polarized light that is obliquely incident onto the discotic CLC layer 210 as a circularly polarized output light. In some embodiments, the discotic CLC layer 210 (e.g., discotic CLC layer 340 or 360) may function as a positive C-plate having a substantially zero in-plane retardance and a positive out-of-plane retardance. The positive C-plate property of the discotic CLC layer 210 may compensate for the negative C-plate property of the calamitic CLC layer 205. For example, the discotic CLC layer 210 may be configured to provide an additional phase shift (referred to as a second phase shift) to the incident light 202 of the CLC reflective polarizer 200.

In some embodiments, the second phase shift provided by the discotic CLC layer 210 may be configured to be opposite to the first phase shift provided by the calamitic CLC layer 205. In some embodiments, the second phase shift provided by the discotic CLC layer 210 may be configured to at least partially cancel out the first phase shift provided by the calamitic CLC layer 205. In some embodiments, through respectively configuring the out-of-plane retardance of the discotic CLC layer 210, the second phase shift provided by the discotic CLC layer 210 may be configured to substantially cancel out the entire first phase shift provided by the calamitic CLC layer 205. Thus, an overall phase shift provided to the incident light 202 by the CLC reflective polarizer 200 may be smaller than the first phase shift provided by the calamitic CLC layer 205 only. In some embodiments, the overall phase shift provided to the incident light 202 by the CLC reflective polarizer 200 may be substantially zero. Thus, the depolarization of the reflected light and/or the transmitted light caused by the calamitic CLC layer 205 may be reduced. Accordingly, the light leakage of the CLC reflective polarizer 200 may be significantly reduced, and the extinction ratio of the CLC reflective polarizer 200 may be significantly increased.

Referring to FIG. 2A, each of the calamitic CLC layer 205 and the discotic CLC layer 210 may be configured with a constant helix pitch or a varying helix pitch. In some embodiments, both of the calamitic CLC layer 205 and the discotic CLC layer 210 may be configured with a constant helix pitch, or both of the calamitic CLC layer 205 and the discotic CLC layer 210 may be configured with a varying helix pitch. In some embodiments, one of the calamitic CLC layer 205 and the discotic CLC layer 210 may be configured with a constant helix, and the other one of the calamitic CLC layer 205 and the discotic CLC layer 210 may be configured with a varying helix pitch. In some embodiments, the helical structures of the calamitic CLC layer 205 and the discotic CLC layer 210 may be configured with the same handedness. The same handedness of the helical structures of the calamitic CLC layer 205 and the discotic CLC layer 210 may be referred to as a handedness of the helical structure of the CLC reflective polarizer 200.

In some embodiments, the calamitic CLC layer 205 and the discotic CLC layer 210 may be configured with non-overlapping reflection bands, overlapping reflection bands, or a substantially same reflection band. In some embodiments, the reflection bands of the calamitic CLC layer 205 and the discotic CLC layer 210 may at least partially overlap with one another. In some embodiments, both of the calamitic CLC layer 205 and the discotic CLC layer 210 may be configured with a constant helix pitch and a substantially same reflection band or overlapping reflection bands. Accordingly, the CLC reflective polarizer 200 may function as a narrow band reflective polarizer with a low light leakage (e.g., lower than 5%, 2%, 1%, etc.). In some embodiments, both of the calamitic CLC layer 205 and the discotic CLC layer 210 may be configured with a varying helix pitch and a substantially same reflection band or overlapping reflection bands. Accordingly, the CLC reflective polarizer 200 may function as a broadband reflective polarizer with a low light leakage (e.g., lower than 5%, 2%, 1%, etc.).

For discussion purposes, FIG. 2A shows that the light 202 is obliquely incident onto the CLC reflective polarizer 200 from the calamitic CLC layer 205 side. In some embodiments, the light 202 may be obliquely incident onto the CLC reflective polarizer 200 from the discotic CLC layer 210 side. In some embodiments, the incident light 202 may be a circularly polarized light having a handedness that is the same as the handedness of the helical structure of the CLC reflective polarizer 200, and having a wavelength range within a reflection band of the CLC reflective polarizer 200. For discussion purposes, the incident light 202 may be an LHCP light, and the CLC reflective polarizer 200 may be a left-handed CLC reflective polarizer.

Due to the optical compensation of the positive C-plate property of the discotic CLC layer 210 and the negative C-plate property of the calamitic CLC layer 205, the CLC reflective polarizer 200 may substantially reflect the LHCP light 202 as an LHCP light 204 with a low light leakage. In some embodiments, the incident light 202 may be an unpolarized polarized light or a linearly polarized light including an RHCP component and an LHCP component. Due to the optical compensation of the positive C-plate property of the discotic CLC layer 210 and the negative C-plate property of the calamitic CLC layer 205, the CLC reflective polarizer 200 may substantially reflect the LHCP component of the incident light 202 as an LHCP light 204, and substantially transmit the RHCP component of the incident light 202 as an RHCP light 206, with a low light leakage.

FIG. 2B schematically illustrates a y-z sectional view of an LC device 230, according to an embodiment of the present disclosure. The LC device 230 may function as a circular reflective polarizer configured to selectively reflect or transmit a circularly polarized light with a low light leakage. The LC device 230 may include elements that are similar to those included in the LC device 200 shown in FIG. 2A. Descriptions of the similar elements may refer to the above descriptions rendered in connection with FIG. 2A. As shown in FIG. 2B, the LC device 230 may include a stack of CLC layers 205a, 205b, and 210a. The LC device 230 may also be referred to as a CLC reflective polarizer 230. The stack of CLC layers 205a, 205b, and 210a may include a plurality of calamitic (or rod-like, or rod-shaped) CLC layers 205a and 205b, and at least one discotic (or disc-like, or disc-shaped) CLC layer 210a arranged in a predetermined order.

For discussion purposes, FIG. 2B shows that the CLC reflective polarizer 230 includes two calamitic CLC layers 205a and 205b, and one discotic CLC layer 210a arranged in a predetermined order. The discotic CLC layer 210a may function as a compensation layer (e.g., positive C-plate) configured to provide an optical compensation at oblique incidence angles. For example, for an oblique incident light of the CLC reflective polarizer 230, a phase shift provided by the discotic CLC layer 210a may be configured to at least partially cancel out a phase shift provided by a combination of the calamitic CLC layers 205a and 205b. Thus, the light leakage of the CLC reflective polarizer 230 may be reduced, and the extinction ratio of the CLC reflective polarizer 230 may be increased.

The CLC reflective polarizer 230 may be configured with a broad reflection band. In some embodiments, the CLC reflective polarizer 230 may include a plurality of single-pitch CLC layers, each configured for a specific wavelength range. For example, to achieve a broad reflection band, e.g., covering the entire visible wavelength range, the CLC reflective polarizer 230 may include a plurality of single-pitch CLC layers, each configured for a specific wavelength range corresponding to a specific color. In the embodiment shown in FIG. 2B, the CLC reflective polarizer 230 may include three single-pitch CLC layers: a first CLC layer 205a that is a calamitic CLC layer having a reflection band in the wavelength range of blue lights (referred to as a “B-CLC” layer 205a), a second CLC layer 205b that is a calamitic CLC layer having a reflection band in the wavelength range of green lights (referred to as a “G-CLC” layer 205b), and a third CLC layer 210a that is a discotic CLC layer having a reflection band in the wavelength range of red lights (referred to as an “R-CLC” layer 210a). In the embodiment shown in FIG. 2B, the second CLC layer (e.g., “G-CLC” layer) 205b may be disposed between the first CLC layer (e.g., “B-CLC” layer) 205a and the third CLC layer (e.g., “R-CLC” layer) 210a.

In addition, the third CLC layer (e.g., “R-CLC” layer) 210a may function as compensation layer (e.g., positive C-plate) configured to provide an optical compensation at oblique incidence angles. In some embodiments, a second phase shift provided by the third CLC layer (e.g., “R-CLC” layer) 210a may be configured to at least partially cancel out a first phase shift provided by a combination of the first CLC layer (e.g., “B-CLC” layer) 205a and the second CLC layer (e.g., “G-CLC” layer) 205b. Thus, when a light 232 is obliquely incident onto the CLC reflective polarizer 230, an overall phase shift provided to the obliquely incident light 232 by the CLC reflective polarizer 230 may be reduced as compared to each of the first phase shift and the second phase shift.

In some embodiments, through respectively configuring the out-of-plane retardance of the third CLC layer (e.g., “R-CLC” layer) 210a, the second phase shift provided by the third CLC layer (e.g., “R-CLC” layer) 210a may be configured to substantially cancel out the first phase shift provided by the combination of the first CLC layer (e.g., “B-CLC” layer) 205a and the second CLC layer (e.g., “G-CLC” layer) 205b. An overall phase shift experienced by the obliquely incident light 232 when propagating inside the CLC reflective polarizer 230 may be substantially zero. Thus, the depolarization of the reflected light and/or the transmitted light caused by the calamitic CLC layers 205a and 205b may be reduced. Accordingly, the light leakage of the CLC reflective polarizer 230 may be significantly reduced, and the extinction ratio of the CLC reflective polarizer 230 may be significantly increased.

For discussion purposes, the light 232 incident onto the CLC reflective polarizer 230 may be a broadband LHCP light 232 including potions of LHCP blue, green, and red lights having a central wavelength of about 450 nm, about 530 nm, and about 630 nm, respectively. The CLC reflective polarizer 230 may be a left-handed CLC reflective polarizer. When propagating in the CLC reflective polarizer 230, the portions of LHCP blue, green, and red lights may be primarily or substantially reflected by the CLC reflective polarizer 230 as an LHCP blue light, an LHCP green light, and an LHCP red light, respectively, which are subsequently combined to be visually observed as a broadband LHCP light 234, with a low light leakage.

FIG. 2C schematically illustrates a y-z sectional view of an LC device 250, according to an embodiment of the present disclosure. The LC device 250 may function as a circular reflective polarizer configured to selectively reflect or transmit a circularly polarized light with a low light leakage. The LC device 250 may include elements that are similar to those included in the LC device 200 shown in FIG. 2A, or the LC device 230 shown in FIG. 2B. Descriptions of the similar elements may refer to the above descriptions rendered in connection with FIG. 2A or FIG. 2B.

As shown in FIG. 2C, the LC device 250 may include a stack of CLC layers 205a, 205b, 210a, and 205c. The LC device 250 may also be referred to as a CLC reflective polarizer 250. The stack of CLC layers 205a, 205b, 210a, and 205c may include a plurality of calamitic (or rod-like, or rod-shaped) CLC layers 205a, 205b, and 205c, and at least one discotic (or disc-like, or disc-shaped) CLC layer 210a arranged in a predetermined order. For discussion purposes, FIG. 2C shows that the CLC reflective polarizer 250 includes three calamitic CLC layers 205a, 205b, and 205c, and one discotic CLC layer 210a arranged in a predetermined order. The number of calamitic CLC layers and the number of discotic CLC layers are not limited to those shown in FIG. 3C. The CLC reflective polarizers 250 may include other suitable number of calamitic CLC layers and other suitable number of discotic CLC layers. The discotic CLC layer 210a may function as a compensation layer (e.g. positive C-plate) configured to provide an optical compensation at oblique incidence angles. For example, for an oblique incident light of the CLC reflective polarizer 230, a phase shift provided by the discotic CLC layer 210a may be configured to at least partially cancel out a phase shift provided by a combination of the calamitic CLC layers 205a, 205b, and 205c. Thus, the light leakage of the CLC reflective polarizer 250 may be reduced, and the extinction ratio of the CLC reflective polarizer 250 may be increased.

For example, to achieve a broad reflection band, e.g., covering the entire visible wavelength range, the CLC reflective polarizer 250 may include a plurality of single-pitch CLC layers, each configured for a specific wavelength range corresponding to a specific color. In the embodiment shown in FIG. 2C, the CLC reflective polarizer 250 may include four single-pitch CLC layers: the first CLC layer 205a that is a calamitic CLC layer having a reflection band in the wavelength range of blue lights (referred to as a “B-CLC” layer 205a), the second CLC layer 205b that is a calamitic CLC layer having a reflection band in the wavelength range of green lights (referred to as a “G-CLC” layer 205b), the third CLC layer 210a that is a discotic CLC layer having a reflection band in the wavelength range of red lights (referred to as an “R-CLC” layer 210a), and a fourth CLC layer 205c that is a calamitic CLC layer having a reflection band in the wavelength range of orange lights (referred to as an “O-CLC” layer 205c). In the embodiment shown in FIG. 2C, the second CLC layer (e.g., “G-CLC” layer) 205b may be disposed between the first CLC layer (e.g., “B-CLC” layer) 205a and the third CLC layer (e.g., “R-CLC” layer) 210a, and the third CLC layer (e.g., “R-CLC” layer) 210a may be disposed between the second CLC layer (e.g., “G-CLC” layer) 205b and the fourth CLC layer (e.g., “0-CLC” layer) 205c.

The third CLC layer (e.g., “R-CLC” layer) 210a may function as a compensation layer (e.g., positive C-plate) configured to provide an optical compensation at oblique incidence angles. In some embodiments, a second phase shift provided by the third CLC layer (e.g., “R-CLC” layer) 210a may be configured to at least partially cancel out a first phase shift provided by a combination of the first CLC layer (e.g., “B-CLC” layer) 205a, the second CLC layer (e.g., “G-CLC” layer) 205b, and the fourth CLC layer (e.g., “O-CLC” layer) 205c. Thus, when a light 252 is obliquely incident onto the CLC reflective polarizer 250, an overall phase shift provided to the obliquely incident light 252 by the CLC reflective polarizer 250 may be reduced as compared to each of the first phase shift and the second phase shift.

In some embodiments, through respectively configuring the out-of-plane retardance of the third CLC layer (e.g., “R-CLC” layer) 210a, the second phase shift provided by the third CLC layer (e.g., “R-CLC” layer) 210a may be configured to substantially cancel out the first phase shift provided by the combination of the first CLC layer (e.g., “B-CLC” layer) 205a, the second CLC layer (e.g., “G-CLC” layer) 205b, and the fourth CLC layer (e.g., “O-CLC” layer) 205c. Thus, an overall phase shift experienced by the obliquely incident light 252 when propagating inside the CLC reflective polarizer 250 may be substantially zero. Thus, the depolarization of the reflected light and/or the transmitted light caused by the calamitic CLC layers 205a, 205b, and 205c may be reduced. Accordingly, the light leakage of the CLC reflective polarizer 250 may be significantly reduced, and the extinction ratio of the CLC reflective polarizer 250 may be significantly increased.

For discussion purposes, the light 252 incident onto the CLC reflective polarizer 250 may be a broadband LHCP light 252 including potions of LHCP blue, green, red, and orange lights. The CLC reflective polarizer 250 may be a left-handed CLC reflective polarizer. When propagating in the CLC reflective polarizer 250, the portions of LHCP blue, green, red, and orange lights may be substantially (or primarily) reflected by the CLC reflective polarizer 250 as an LHCP blue light, an LHCP green light, an LHCP red light, and an LHCP orange light, respectively, which are subsequently combined to be visually observed as a broadband LHCP light 254, with a low light leakage.

The stack configuration and the number of the CLC layers shown in FIGS. 2A-2C are for illustration only. Other suitable arrangements or suitable number (e.g., five or more than five) of CLC layers may also be used. For example, one or more additional CLC-layers for other colors may be added, such as a yellow-CLC layer, a purple-CLC layer, etc. In addition, the number of the calamitic CLC layers may also be any suitable number, such one two, three, four, five, or six, etc., and the number of the discotic CLC layers may also be any suitable number, such as one, two, three, or four, etc. For example, in some embodiments, the CLC reflective polarizer 230 shown in FIG. 2B may be configured to include one calamitic CLC layer and two discotic CLC layers. For example, the B-CLC layer 205a may be a calamitic CLC layer, and the G-CLC layer 205b and the R-CLC layer 210a may be discotic CLC layers. In some embodiments, the G-CLC layer 205b may be a calamitic CLC layer, and the B-CLC layer 205a and the R-CLC layer 210a may be discotic CLC layers.

In some embodiments, the CLC reflective polarizer 250 shown in FIG. 2C may be configured to include two calamitic CLC layers and two discotic CLC layers. In some embodiments, the B-CLC layer 205a and the G-CLC layer 205b may be calamitic CLC layers, and the R-CLC layer 210a and the O-CLC layer 205c may be discotic CLC layers. In some embodiments, the B-CLC layer 205a and the O-CLC layer 205c may be calamitic CLC layers, and the R-CLC layer 210a and the G-CLC layer 205b may be discotic CLC layers. In some embodiments, the O-CLC layer 205c and the G-CLC layer 205b may be calamitic CLC layers, and the R-CLC layer 210a and the B-CLC layer 205a may be discotic CLC layers.

In some embodiments, the CLC reflective polarizer 250 shown in FIG. 2C may be configured to include one calamitic CLC layer and three discotic CLC layers. In some embodiments, the B-CLC layer 205a may be a calamitic CLC layer, and the G-CLC layer 205b, the R-CLC layer 210a, and the O-CLC layer 205c may be discotic CLC layers. In some embodiments, the G-CLC layer 205b may be a calamitic CLC layer, and the B-CLC layer 205a, the R-CLC layer 210a, and the O-CLC layer 205c may be discotic CLC layers. In some embodiments, the O-CLC layer 205c may be a calamitic CLC layer, and the B-CLC layer 205a, the R-CLC layer 210a, and the G-CLC layer 205b may be discotic CLC layers. In some embodiments, the R-CLC layer 210a may be a calamitic CLC layer, and the B-CLC layer 205a, the G-CLC layer 205b, and the O-CLC layer 205c may be discotic CLC layers. In some embodiments, the order of the different CLC layers may be different from the order shown in FIG. 2A, FIG. 2B, and FIG. 2C. Any other suitable order for the stacked CLC layers may be used.

A conventional CLC reflective polarizer may include one or more calamitic CLC layers, and one or more conventional compensation films (e.g., positive C-plates) for providing an optical compensation at oblique incidence angles. A conventional compensation film (e.g., positive C-plate) typically includes multi-birefringent films made by stretched polymer or LC materials, rather than the discotic CLC layer disclosed herein. For example, a conventional C-plate may include positive LCs that are homeotropically aligned (e.g., with LC directors aligned in the thickness or out-of-plane direction), or negative LCs that are homogeneous aligned (e.g., with LC directors aligned in the in-plane direction. The conventional compensation film (e.g., positive C-plate) may transmit lights independent of a polarization, without selectively reflecting or transmitting a circularly polarized light based on the handedness of the light.

Compared to a conventional CLC reflective polarizer, in the disclosed CLC reflective polarizer, the discotic CLC layer itself may function or serve as the positive C-plate in addition to selectively reflecting or transmitting a circularly polarized light based on the handedness of the light. In other words, conventional C-plates may be omitted from the disclosed CLC reflective polarizer. Thus, compared to a conventional CLC reflective polarizer, the number of layers or films included in the disclosed CLC reflective polarizer may be reduced. Accordingly, the thickness of the disclosed CLC reflective polarizer may be reduced.

In some embodiments, the multiple CLC layers included in the disclosed CLC reflective polarizer may be LCP films or layers. In some embodiments, the multiple CLC layers may be directly fabricated as a stack on a substrate to form the disclosed CLC reflective polarizer. In some embodiments, the multiple CLC layers may be indirectly fabricated as a stack (with other elements disposed between the CLC layers) on a substrate to form the disclosed CLC reflective polarizer. In some embodiments, the multiple CLC layers may be fabricated using the same process, e.g., through forming (e.g., spin-coating) a thin film of CLC material, and polymerizing the thin film. In some embodiments, the multiple CLC layers may be directly formed (e.g., coated) on an optical element of a high curvature. For example, the optical element of the high curvature may be used as a substate on which the multiple CLC layers are formed. In some embodiments, the multiple CLC layers may be laminated on an optical element of a high curvature. That is, the multiple CLC layers may be fabricated as flexible layers, which may then be laminated on the optical element of the high curvature. In some embodiments, compared to stretched polarizing films used in a conventional linear reflective polarizer and a conventional linear absorptive polarizer, the disclosed LCP films may exhibit an enhanced performance when coated or laminated on an optical element of a high curvature. In some embodiments, the multiple CLC layers may be configured to be index-matched layers, such that an optical loss at an interface between neighboring CLC layers may be reduced.

A conventional circular absorptive polarizer includes at least two elements stacked together, e.g., a linear absorptive polarizer and a quarter-wave plate (“QWP”). For an unpolarized incident light including two orthogonally linearly polarized components, the linear absorptive polarizer may substantially transmit one of the two orthogonally linearly polarized components as a linearly polarized light, and substantially block, via absorption, the other one of the two orthogonally linearly polarized components. A polarization axis of the QWP may be oriented relative to a polarization axis of the linear absorptive polarizer, such that the QWP may convert the linearly polarized light received from the linear absorptive polarizer as a circularly polarized light with a predetermined handedness, while transmitting the linearly polarized light. An alignment between the linear absorptive polarizer and the QWP may increase the fabrication complexity.

In view of the limitations in the conventional technology, the present disclosure provides an optical film based on a birefringent medium having a chirality. The optical film may function as a circular absorptive polarizer. The optical film may be configured to strongly absorb a first circularly polarized light having a predetermined handedness, and weakly absorb a second circularly polarized light having a handedness opposite to the predetermined handedness. In other words, the optical film may be configured to absorb the first circularly polarized light having the predetermined handedness more than the second circularly polarized light having the opposite handedness. More generally, the optical film may be configured to absorb a first polarized light having a first polarization more than a second polarization light having an orthogonal polarization.

In some embodiments, the optical film may be configured to selectively reflect or absorb a circularly polarized light depending on the handedness of the circularly polarized light. For example, the optical film may be configured to substantially absorb the first circularly polarized light having the predetermined handedness, and substantially reflect the second circularly polarized light having the opposite handedness. In some embodiments, the optical film may be configured to selectively transmit or absorb a circularly polarized light depending on the handedness of the circularly polarized light. For example, the optical film may be configured to substantially absorb the first circularly polarized light having the predetermined handedness, and substantially transmit the second circularly polarized light having the opposite handedness.

In some embodiments, the optical film may include a birefringent medium having a chirality that includes a host birefringent material and dyes doped into the host birefringent material. In some embodiments, the host birefringent material may have an intrinsic chirality. In some embodiments, the birefringent medium may further include chiral dopants doped into the host birefringent material for introducing the chirality. In some embodiments, the dyes may exhibit a circular dichroism. The orientations of the dyes may be configured, such that the dyes may absorb the first circularly polarized light having the predetermined handedness more than the second circularly polarized light having the opposite handedness. For example, the dyes may be oriented to strongly absorb the first circularly polarized light having the predetermined handedness, and weakly absorb the second circularly polarized light having the opposite handedness. Accordingly, the optical film may be configured to absorb the first circularly polarized light having the predetermined handedness more than the second circularly polarized light having the opposite handedness.

In some embodiments, the birefringent medium may further include chiral dopants doped into the host birefringent material (e.g., nematic LCs) for introducing the chirality. In addition, the chiral dopants may have an intrinsically circular dichroism. The chiral dopants may be configured to intrinsically absorb the first circularly polarized light having the predetermined handedness more than the second circularly polarized light having the opposite handedness. For example, the chiral dopants may strongly absorb the first circularly polarized light having the predetermined handedness and weakly absorb the second circularly polarized light having the opposite handedness. Accordingly, the optical film may be configured to absorb the first circularly polarized light having the predetermined handedness more than the second circularly polarized light having the opposite handedness. In other words, the chiral dopants may function as dyes with circular dichroism, and additional dyes may not be included for causing the absorption.

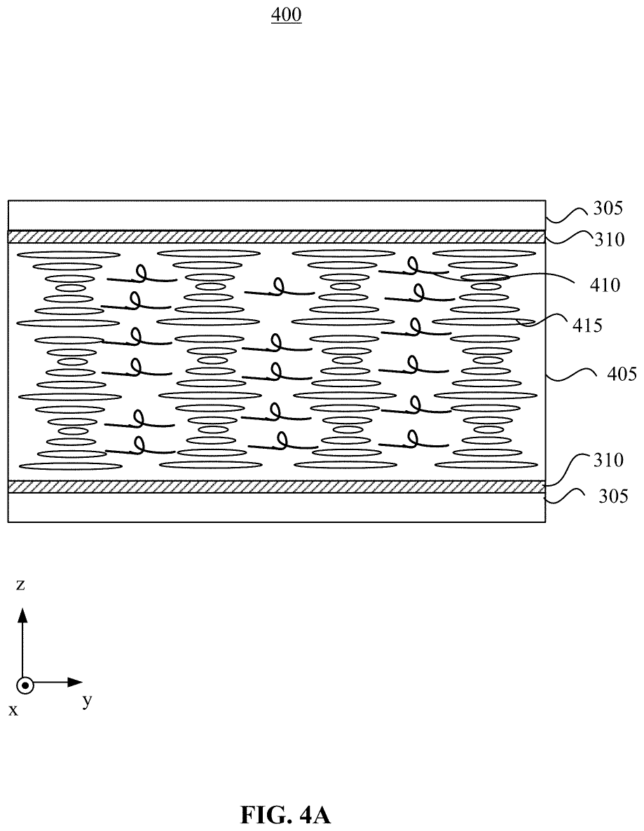

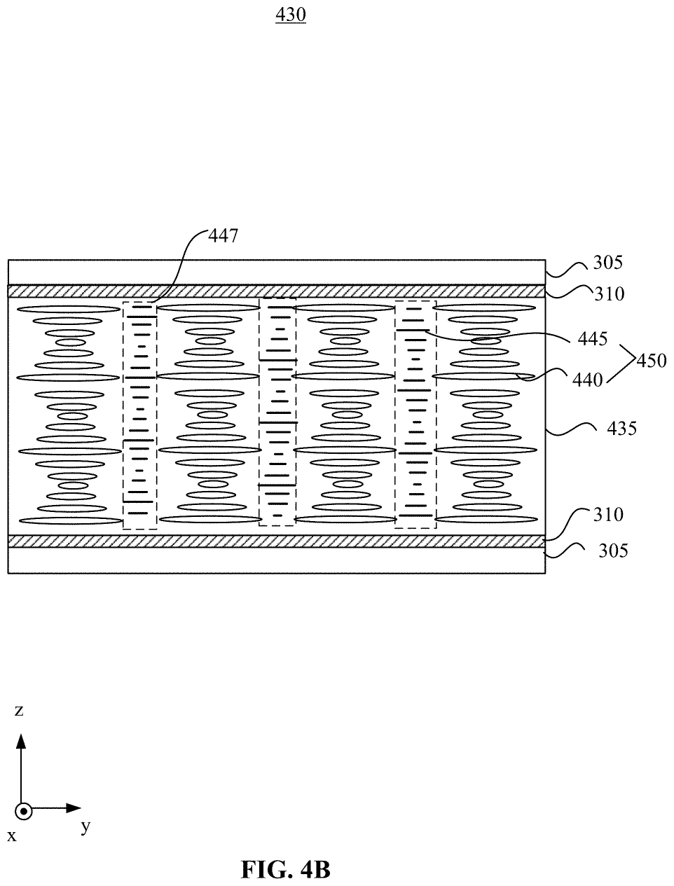

FIG. 4A schematically illustrates a y-z sectional view of an LC device 400, according to an embodiment of the present disclosure. The LC device 400 may function as a circular absorptive polarizer. The LC device 400 may include elements that are similar to those included in the LC device 200 shown in FIG. 2A, the LC device 230 shown in FIG. 2B, the LC device 250 shown in FIG. 2C, the CLC layer 300 shown in FIG. 3A, the CLC layer 320 shown in FIG. 3B, the CLC layer 340 shown in FIG. 3C, or the CLC layer 360 shown in FIG. 3D. Descriptions of the similar elements may refer to the above descriptions rendered in connection with FIGS. 2A-2C, and FIGS. 3A-3D.

As shown in FIG. 4A, the LC device 400 may include two substates 305, the alignment layers 310, and an LC layer 405 disposed between the two substates 305. In some embodiments, the LC layer 405 may be an LCP film or LCP layer. In some embodiments, the alignment layers 310 and/or the substates 305 may be omitted. In some embodiments, the LC layer 405 may be an active LC layer including active LCs. In some embodiments, the LC layer 405 may include a mixture of chiral LCs 415 and dyes 410 doped into the chiral LCs 415. In some embodiments, the LC layer 405 may be referred to as a CLC layer doped with dyes. In some embodiments, the chiral LCs 415 may include a host birefringent material (e.g., nematic LCs) doped with chiral dopants (not shown). In some embodiments, the chiral LCs 415 may have an intrinsic chirality. The chiral LCs 415 may be configured with a helical structure. For discussion purposes, FIG. 4A shows that the chiral LCs 415 may include calamitic LC molecules arranged in a helical structure having a constant helix pitch.

In some embodiments, the dyes 410 may include helical molecules having π-conjugated systems to exhibit efficient light absorption and/or emission, such as helicenes, 1,1′-binaphthyls, naphthalenediimide, etc. In some embodiments, the dyes 410 may include boron dipyrromethene (“BODIPY”), and the dyes 410 may be referred to as BODIPY dyes. In some embodiments, the dyes 410 may include chiral BODIPY dyes. Chiral BODIPY dyes may be obtained by adding chiral substituents to achiral BODIPYs or tweaking the structure of BODIPYs to be intrinsically chiral. In some embodiments, a molecule of the chiral BODIPY dyes may have a molecular helix with an induced axial chirality. The molecular helix may have a predetermined rotating direction (e.g., a clockwise direction or a counter-clockwise direction). In some embodiments, the chiral BODIPY dyes may exhibit a strong circular dichroism in the visible band. In some embodiments, the chiral BODIPY dyes may absorb a visible light due to the electron transfer from the highest energy occupied molecular orbital (“HOMO”) to the lowest energy unoccupied molecular orbital (“LUMO”).

In some embodiments, the molecules of the chiral BODIPY dyes may be oriented, such that the molecular helices of the molecules may be configured to have the same rotating direction within the volume of the chiral BODIPY dyes. In other words, the molecular helices of the molecules may exhibit a same handedness within the volume of the chiral BODIPY dyes. In some embodiments, the chiral BODIPY dyes may be configured to strongly absorb a circularly polarized light having a handedness that is the same as the handedness of the molecular helices of the chiral BODIPY dyes, and weakly absorb a circularly polarized light having a handedness that is opposite to the handedness of the molecular helices of the chiral BODIPY dyes. In some embodiments, the chiral BODIPY dyes may be configured to weakly absorb a circularly polarized light having a handedness that is the same as the handedness of the molecular helices of the chiral BODIPY dyes, and strongly absorb a circularly polarized light having a handedness that is opposite to the handedness of the molecular helices of the chiral BODIPY dyes.

For example, in some embodiments, within a first wavelength range, the chiral BODIPY dyes may be configured to strongly absorb a circularly polarized light having a handedness that is the same as the handedness of the molecular helices of the chiral BODIPY dyes, and weakly absorb a circularly polarized light having a handedness that is opposite to the handedness of the molecular helices of the chiral BODIPY dyes. Within a second wavelength range different from the first wavelength range, the chiral BODIPY dyes may be configured to weakly absorb a circularly polarized light having a handedness that is the same as the handedness of the molecular helices of the chiral BODIPY dyes, and strongly absorb a circularly polarized light having a handedness that is opposite to the handedness of the molecular helices of the chiral BODIPY dyes.

In some embodiments, the chiral LCs 415 may be configured to align or orient the dyes 410 to have a twisted rotation. In some embodiments, the chiral LCs 415 may be configured to align or orient the dyes 410 to have an “out-of-phase” twisted rotation, and the absorption cross-section of the dyes 410 may be oriented such that a circularly polarized light having a predetermined handedness may be strongly absorbed by the dyes 410, and a circularly polarized light having a handedness that is orthogonal to predetermined handedness may be weakly absorbed by the dyes 410. For example, the chiral LCs 415 may be configured to align or orient the molecules of the dyes (e.g., chiral BODIPY dyes) 410 in a substantially same direction within the volume of the LC layer 405. In addition, the molecular helices of the molecules of the dyes (e.g., chiral BODIPY dyes) 410 may be configured to have the same rotating direction (or the same handedness) within the volume of the LC layer 405. In some embodiments, the chiral LCs 415 may be configured to align or orient the molecular helices of the molecules of the dyes (e.g., chiral BODIPY dyes) 410 to rotate in the same rotating direction, along a same predetermined direction within the volume of the LC layer 405. Thus, a circularly polarized light having a predetermined handedness may be strongly absorbed by the LC layer 405, and a circularly polarized light having a handedness that is orthogonal to predetermined handedness may be weakly absorbed by the LC layer 405. Accordingly, the LC device 400 may substantially block, via absorption, a circularly polarized light having predetermined handedness, and substantially reflect or transmit a circularly polarized light having a handedness that is orthogonal to predetermined handedness.

In some embodiments, the chiral LCs 415 may be configured to align or orient the dyes 410 to have an “in-phase” twisted rotation, the absorption cross-section of the dyes 410 may be oriented such that a circularly polarized light may be strongly absorbed by the dyes 410 independent of the handedness. For example, the chiral LCs 415 may be configured to align or orient the molecules of the dyes (e.g., chiral BODIPY dyes) 410 in different directions within the volume of the LC layer 405, e.g., following the orientations of the chiral LCs 415. In some embodiments, the chiral LCs 415 may be configured to align or orient the molecular helices of the molecules of the dyes (e.g., chiral BODIPY dyes) 410 to rotate in the same rotating direction, along a plurality of different directions within the volume of the LC layer 405. Thus, a circularly polarized light may be strongly absorbed by the LC layer 405 independent of the handedness. Accordingly, the LC device 400 may substantially block, via absorption, a circularly polarized light independent of the handedness.

FIG. 4B schematically illustrates a y-z sectional view of an LC device 430, according to an embodiment of the present disclosure. The LC device 430 may function as a circular absorptive polarizer. The LC device 430 may include elements that are similar to those included in the LC device 200 shown in FIG. 2A, the LC device 230 shown in FIG. 2B, the LC device 250 shown in FIG. 2C, the CLC layer 300 shown in FIG. 3A, the CLC layer 320 shown in FIG. 3B, the CLC layer 340 shown in FIG. 3C, the CLC layer 360 shown in FIG. 3D, or the LC device 400 shown in FIG. 4A. Descriptions of the similar elements may refer to the above descriptions rendered in connection with FIG. 2A, FIG. 2B, FIG. 2C, FIG. 3A-FIG. 3D, or FIG. 4A.

As shown in FIG. 4B, the LC device 430 may include two substates 305, the alignment layers 310, and an LC layer 435 disposed between the two substates 305. In some embodiments, the LC layer 435 may be an LCP film or LCP layer. In some embodiments, the alignment layers 310 and/or the substates 305 may be omitted. In some embodiments, the LC layer 435 may be an active LC layer including active LCs. In some embodiments, the LC layer 435 may include chiral LCs 450. In some embodiments, the chiral LCs 450 may include a host birefringent material (e.g., nematic LCs) 440 doped with chiral dopants 445. For discussion purposes, FIG. 4B shows that the chiral LCs 450 may include calamitic LC molecules 440 arranged in a helical structure having a constant helix pitch.

In some embodiments, the chiral dopants 445 may exhibit an intrinsic circular dichroism. The chiral dopants 445 may be configured to intrinsically strongly absorb a circularly polarized light having a predetermined handedness, and weakly absorb a circularly polarized light having a handedness that is orthogonal to predetermined handedness. In other words, the chiral dopant 445 itself may function as a circular absorber. In some embodiments, molecules of the chiral dopant 445 may form a plurality of supramolecules within the volume of the LC layer 435. For example, in some embodiments, the chiral dopants 445 may include prolinol-derived squaraine, which may exhibit a supramolecular aggregation, e.g., in a solution. For example, the prolinol functional groups may serve as aggregation directing chiral centers for a homochiral, helical aggregation of squaraine backbones (also referred to as 445 for discussion purposes), and the squaraine backbones 445 may aggregate to form supramolecules 447 within the volume of the LC layer 435. Long helical molecular stacking axis may be oriented within the plane (e.g., an x-y plane) of the substrate 305, with random in-plane orientations.

A molecular helix of the supramolecule 447 may be configured to rotate in a predetermined direction (e.g., a clockwise direction or a counter-clockwise direction), along an axial direction (e.g., a z-axis direction shown in FIG. 4A) of the LC layer 435. In other words, the rotation of the molecular helix of the supramolecule 447 may exhibit a handedness. In some embodiments, the molecular helix of the supramolecule 447 may be configured to rotate in a counter-clockwise (e.g., left-handed) direction, along the axial direction (e.g., a z-axis direction shown in FIG. 4A) of the LC layer 435. That is, the supramolecules 447 may be configured to have a counter-clockwise (e.g., left-handed) molecular helix. In some embodiments, the chiral dopants 445 may be configured to strongly absorb an RHCP light and weakly absorb an LHCP light. Accordingly, the LC layer 435 may substantially block an RHCP light via absorption, and substantially reflect or transmit an LHCP light. In some embodiments, the molecular helix of the supramolecule 447 may be configured to rotate in a clockwise (e.g., right-handed), along the axial direction (e.g., a z-axis direction shown in FIG. 4A) of the LC layer 435. That is, the supramolecules 447 may have a clockwise (e.g., right-handed) molecular helix. In some embodiments, the chiral dopants 445 may strongly absorb an LHCP light and weakly absorb an RHCP light. Accordingly, the LC layer 435 may substantially block an LHCP light via absorption, and substantially reflect or transmit an RHCP light.

For example, in some embodiments, both of the helical structure of the LC layer 435 and the molecular helix of the supramolecules 447 of the chiral dopants 445 may have a counter-clockwise (e.g., left-handed) rotation. In such an embodiment, the LC layer 435 may substantially block an RHCP light via absorption, and substantially reflect an LHCP light. Accordingly, the LC device 430 may substantially block an RHCP light via absorption, and substantially reflect an LHCP light. In some embodiments, both of the helical structure of the LC layer 435 and the molecular helix of the supramolecules 447 of the chiral dopants 445 may have a clockwise (e.g., right-handed) rotation. In such an embodiment, the LC layer 435 may substantially block an LHCP light via absorption, and substantially reflect an RHCP light. Accordingly, the LC device 430 may substantially block an LHCP light via absorption, and substantially reflect an RHCP light.

In some embodiments, the helical structure of the LC layer 435 may have a counter-clockwise (e.g., left-handed) rotation, and the molecular helix of the supramolecules 447 of the chiral dopants 445 may have a clockwise (e.g., right-handed) rotation. In such an embodiment, the LC layer 435 may substantially block an LHCP light via absorption, and substantially transmit an RHCP light. Accordingly, the LC device 430 may substantially block an LHCP light via absorption, and substantially transmit an RHCP light. In some embodiments, the helical structure of the LC layer 435 may have a clockwise (e.g., right-handed) rotation, and the molecular helix of the supramolecules 447 of the chiral dopants 445 may have a counter-clockwise (e.g., left-handed) rotation. In such an embodiment, the LC layer 435 may substantially block an RHCP light via absorption, and substantially transmit an LHCP light. Accordingly, the LC device 430 may substantially block an RHCP light via absorption, and substantially transmit an LHCP light.

In some embodiments, both of the helical structure of the LC layer 435 and the molecular helix of the supramolecules 447 of the chiral dopants 445 may have a counter-clockwise (e.g., left-handed), and the LC layer 435 may substantially block an LHCP light via absorption, and substantially transmit an RHCP light. Accordingly, the LC device 430 may substantially block an LHCP light via absorption, and substantially transmit an RHCP light. In some embodiments, both of the helical structure of the LC layer 435 and the molecular helix of the supramolecules 447 of the chiral dopants 445 may have a clockwise (e.g., right-handed) rotation, and the LC layer 435 may substantially block an RHCP light via absorption, and substantially transmit an LHCP light. Accordingly, the LC device 430 may substantially block an RHCP light via absorption, and substantially transmit an LHCP light.

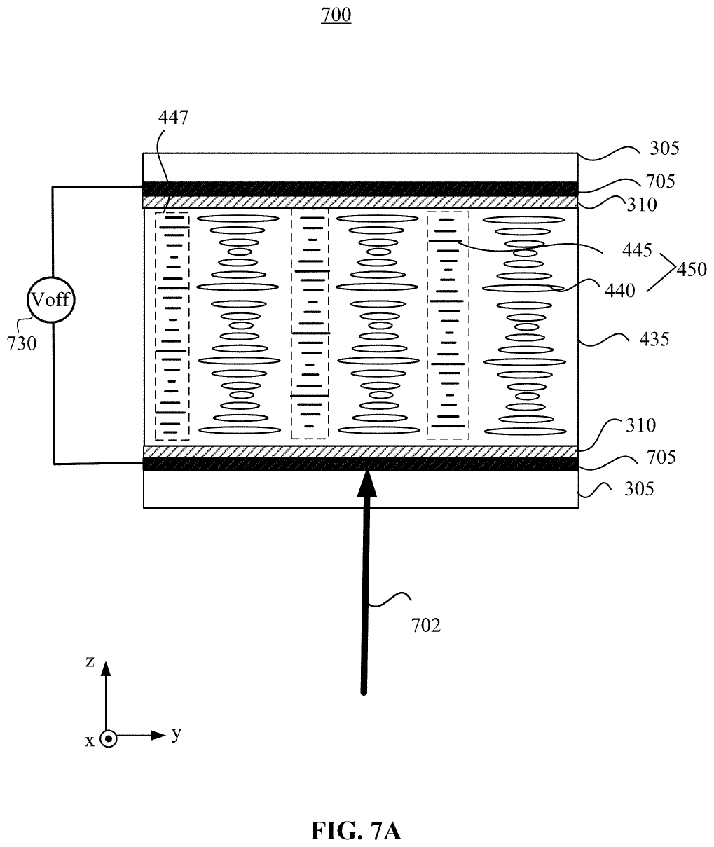

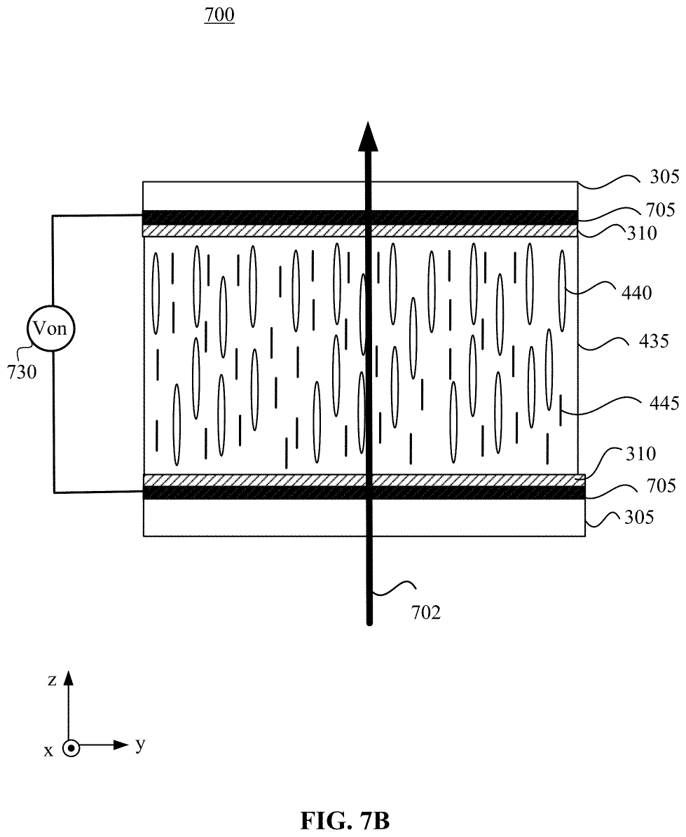

FIG. 7A schematically illustrates a y-z sectional view of an LC device 700 operating at a voltage-off state, according to an embodiment of the present disclosure. FIG. 7B schematically illustrates a y-z sectional view of the LC device 700 operating at a voltage-on state, according to an embodiment of the present disclosure. The LC device 700 may function as a switchable optical shutter that is circular polarization selective. The LC device 700 may include elements that are the same as or similar to those included in the LC device 200 shown in FIG. 2A, the LC device 230 shown in FIG. 2B, the LC device 250 shown in FIG. 2C, the CLC layer 300 shown in FIG. 3A, the CLC layer 320 shown in FIG. 3B, the CLC layer 340 shown in FIG. 3C, the CLC layer 360 shown in FIG. 3D, the LC device 400 shown in FIG. 4A, or the LC device 430 shown in FIG. 4B. Descriptions of the similar elements may refer to the above descriptions rendered in connection with FIGS. 2A-2C, FIGS. 3A-3D, FIG. 4A, or FIG. 4B.

As shown in FIG. 7A, the LC device 700 may include two substates 305, the alignment layers 310, and the LC layer 435 disposed between the two substates 305. The LC device 700 may also include two electrodes 705 coupled to the LC layer 435. The electrodes 705 may be configured to apply a driving voltage provided by a power source 730 to the LC layer 435, thereby tuning the light transmittance of the LC device 700. In some embodiments, the two electrodes 705 may be disposed at different substrates 305. In some embodiments, the two electrodes 705 may be disposed at the same substrate (e.g., at the upper or the lower substrate 305), and an electrical insulating layer may be disposed between the two electrodes 705. Each electrode 705 may be a continuous planar electrode, a patterned planar electrode, or a protrusion electrode. Each electrode 705 may be any suitable conductive electrode, such as indium tin oxide (“ITO”) electrode. In some embodiments, each electrode 705 may include a flexible transparent conductive layer, such as ITO disposed on a plastic film. In some embodiments, the plastic film may include polyethylene terephthalate (“PET”). In some embodiments, the plastic film may include cellulose triacetate (“TAC”), which is a type of flexible plastic with a substantially low birefringence. For discussion purposes, FIG. 7A shows that the two electrodes 705 are planar electrodes disposed at different substrates 305, and disposed between the respective alignment layers 310 and the substrates 305.

In some embodiments, the LC layer 435 may include chiral LCs 450. In some embodiments, the chiral LCs 450 may include the host birefringent material (e.g., nematic LCs) 440 doped with the chiral dopants 445. The host birefringent material (e.g., nematic LCs) 440 may be active LCs. The LC molecules of the host birefringent material (e.g., nematic LCs) 440 are also referred to as 440 for discussion purposes. For discussion purposes, FIG. 7A shows that the chiral LCs 450 may include calamitic LC molecules 440 arranged in a helical structure having a constant helix pitch. The host birefringent material (e.g., nematic LCs) 440 may have a positive or negative dielectric anisotropy, with directors of LC molecules reorientable by an external field. For discussion purpose, in FIG. 7A, the host birefringent material (e.g., nematic LCs) 440 may have a positive dielectric anisotropy. The alignment layers 310 may be configured to provide anti-parallel alignments to the LC molecules 440, in a y-axis direction in FIG. 7A.

As shown in FIG. 7A, when a voltage applied to the LC device 700 is lower than or equal to a threshold voltage of the LC device 700 (e.g., when the power source 730 supplies a substantially zero voltage), the LC device 700 may function similarly to the LC device 430 shown in FIG. 4B. For example, the LC device 700 may substantially block a circularly polarized light with a predetermined handedness via absorption, and substantially transmit or reflect a circularly polarized light with a handedness that is opposite to the predetermined handedness. For discussion purposes, in the embodiment shown in FIG. 7A, the LC layer 435 may be configured to substantially block a circularly polarized light with a predetermined handedness via absorption, and substantially transmit a circularly polarized light with a handedness that is opposite to the predetermined handedness. For example, as shown in FIG. 7A, the LC layer 435 may substantially block an LHCP incident light 702 via absorption. Thus, at the voltage-off state, the LC device 700 may operate in an absorption state for the LHCP incident light 702.

As shown in FIG. 7B, when a voltage is supplied to the LC device 700, an electric field (e.g., along a z-axis direction) may be generated between the two opposite substrates 305. When the voltage is higher than the threshold voltage and is gradually increased, the LC molecules 440 and the molecules of the chiral dopants 445 may trend to be reoriented by the electric field (e.g., may gradually become oriented parallel with the electric field direction). When the voltage is sufficiently high, as shown in FIG. 7B, the LC molecules 440 may be reoriented to be parallel with the electric field direction (e.g., z-axis direction). The molecules of the chiral dopants 445 may be reoriented to be parallel with the electric field direction (e.g., z-axis direction). The supramolecules 447 of the chiral dopants 445 may become untwisted, and may not be formed within the volume of the LC layer 435. Thus, the chiral dopants 445 may not exhibit a circular polarization selective absorption. Instead, the chiral dopants 445 may absorb both of an LHCP light and an RHCP light at substantially the same level, e.g., a substantially low level. For example, the LC layer 435 may substantially transmit the LHCP incident light 702. Thus, at the voltage-on state, the LC device 700 may operate in a transmission state for the LHCP incident light 702.

In the embodiment shown in FIGS. 7A and 7B, for the LHCP incident light 702, the LC device 700 is configured to operate in the absorption state when the voltage supplied by the power source 730 is lower than or equal to the threshold voltage, and operate in the transmission state when the voltage is sufficiently higher than the threshold voltage. In addition, as the voltage gradually increases from the threshold voltage, for the LHCP incident light 702, the light transmittance of the LC device 700 may gradually increase. When the incident light 702 is an RHCP light, the LC device 700 may operate in the transmission state at both of the voltage-off state and the voltage-on state.

Although not shown, in some embodiments, when the incident light 702 is an RHCP light, the LC device 700 is configured to operate in the absorption state when the voltage supplied by the power source 730 is lower than or equal to the threshold voltage, and operate in the transmission state when the voltage is sufficiently higher than the threshold voltage. When the incident light 702 is an LHCP light, the LC device 700 may operate in the transmission state at both of the voltage-off state and the voltage-on state.

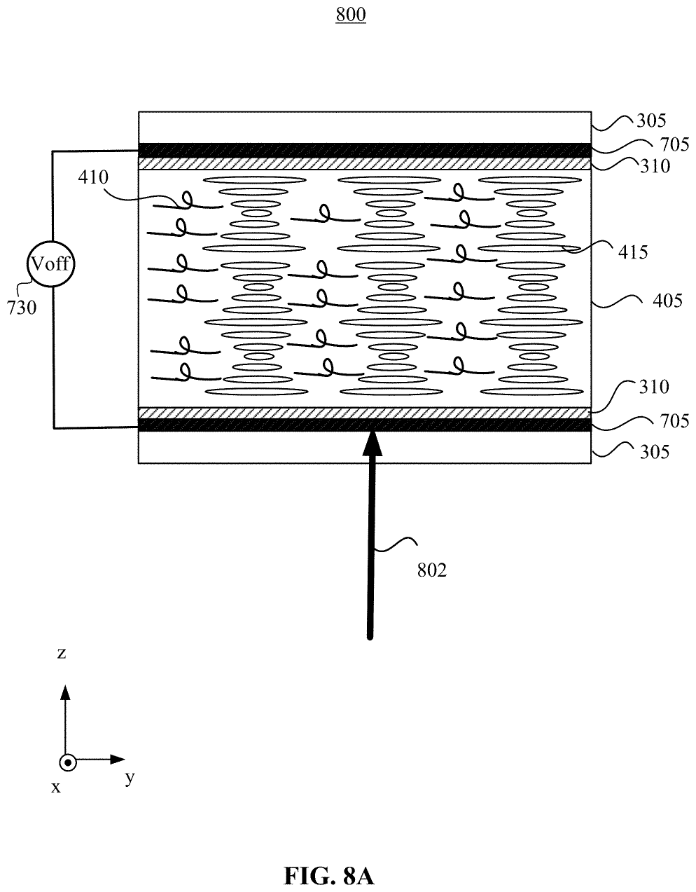

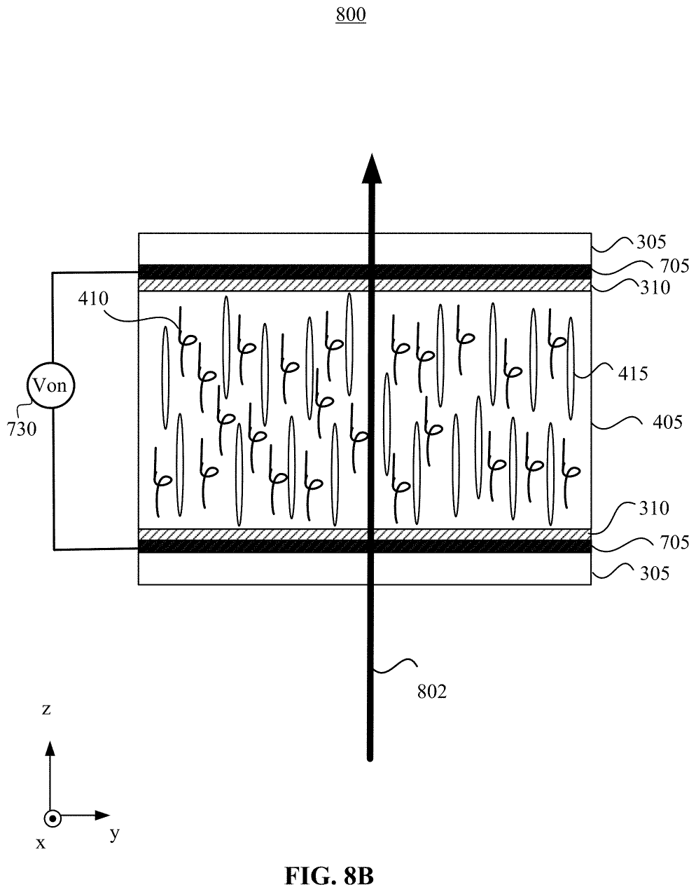

FIG. 8A schematically illustrates a y-z sectional view of an LC device 800 operating at a voltage-off state, according to an embodiment of the present disclosure. FIG. 8B schematically illustrates a y-z sectional view of the LC device 800 operating at a voltage-on state, according to an embodiment of the present disclosure. The LC device 800 may function as a switchable optical shutter that is circular polarization selective. The LC device 800 may include elements that are the same as or similar to those included in the LC device 200 shown in FIG. 2A, the LC device 230 shown in FIG. 2B, the LC device 250 shown in FIG. 2C, the CLC layer 300 shown in FIG. 3A, the CLC layer 320 shown in FIG. 3B, the CLC layer 340 shown in FIG. 3C, the CLC layer 360 shown in FIG. 3D, the LC device 400 shown in FIG. 4A, the LC device 430 shown in FIG. 4B, or the LC device 700 shown in FIGS. 7A and 7B. Descriptions of the similar elements may refer to the above descriptions rendered in connection with FIGS. 2A-2C, FIGS. 3A-3D, FIGS. 4A and 4B, or FIGS. 7A and 7B.

As shown in FIG. 8A, the LC device 800 may include two substates 305, the alignment layers 310, and the LC layer 405 disposed between the two substates 305. The LC device 800 may also include two electrodes 705 coupled to the LC layer 405. The electrodes 705 may be configured to apply a driving voltage provided by the power source 730 to the LC layer 405, thereby tuning the light transmittance of the LC device 800. In some embodiments, the two electrodes 705 may be disposed at different substrates 305. In some embodiments, the two electrodes 705 may be disposed at the same substrate (e.g., at the upper or the lower substrate 305), and an electrical insulating layer may be disposed between the two electrodes 705. Each electrode 705 may be a continuous planar electrode, a patterned planar electrode, or a protrusion electrode. For discussion purposes, FIG. 8A shows that the two electrodes 705 are planar electrodes disposed at different substrates 305, and disposed between the respective alignment layers 310 and the substrates 305.

In some embodiments, the LC layer 405 may include a mixture of chiral LCs 415 and dyes 410 doped into the chiral LCs 415. The chiral LCs 415 may be active LCs. In some embodiments, the chiral LCs 415 may include a host birefringent material (e.g., nematic LCs) doped with chiral dopants (not shown), and the host birefringent material (e.g., nematic LCs) may be active LCs. In some embodiments, the host birefringent material may include dual-frequency LCs, whose dielectric constant may be tunable through tunning the frequency of an electric field applied to the LC layer 405. In some embodiments, the chiral LCs 415 may have an intrinsic chirality. The chiral LCs 415 may be configured with a helical structure. For discussion purposes, FIG. 8A shows that the chiral LCs 415 may include calamitic LC molecules arranged in a helical structure having a constant helix pitch. The LC molecules of the chiral LCs 415 are also referred to as 415 for discussion purposes. The chiral LCs 415 may have a positive or negative dielectric anisotropy. For discussion purpose, in FIG. 8A, the chiral LCs 415 may have a positive dielectric anisotropy. The alignment layers 310 may be configured to provide anti-parallel alignments to the LC molecules 415, in a y-axis direction in FIG. 8A.

As shown in FIG. 8A, when a voltage applied to the LC device 800 is lower than or equal to a threshold voltage of the LC device 800 (e.g., when the power source 730 supplies a substantially zero voltage), the LC device 800 may function similarly to the LC device 400 shown in FIG. 4A. For example, the LC device 800 may substantially block a circularly polarized light with a predetermined handedness via absorption, and substantially transmit or reflect a circularly polarized light with a handedness that is opposite to the predetermined handedness. For discussion purposes, in the embodiment shown in FIG. 8A, the LC layer 405 may be configured to substantially block a circularly polarized light with a predetermined handedness via absorption, and substantially transmit a circularly polarized light with a handedness that is opposite to the predetermined handedness. For example, as shown in FIG. 8A, the LC layer 405 may substantially block an LHCP incident light 802 via absorption. Thus, at the voltage-off state, the LC device 800 may operate in an absorption state for the LHCP incident light 802.

As shown in FIG. 8B, when a voltage is supplied to the LC device 800, an electric field (e.g., along a z-axis direction) may be generated between the two opposite substrates 305. When the voltage is higher than the threshold voltage and is gradually increased, the LC molecules 415 may trend to be reoriented by the electric field (e.g., may gradually become oriented parallel with the electric field direction). The molecules of the dyes 410 may be reoriented with the LC molecules 415 at the voltage-on state. When the voltage is sufficiently high, as shown in FIG. 8B, the LC molecules 415 may be reoriented to be parallel with the electric field direction (e.g., z-axis direction). Accordingly, the molecules of the dyes 410 may be reoriented to be parallel with the electric field direction (e.g., z-axis direction). The absorption cross-section of the dyes 410 may be reoriented, such that the dyes 410 may not exhibit a circular polarization selective absorption. Instead, the dyes 410 may absorb both of an RHCP light and an LHCP light at substantially the same level, e.g., a substantially low level. The LC layer 405 may substantially transmit the incident light (e.g., LHCP light) 802. Thus, at the voltage-on state, the LC device 800 may operate in a transmission state for an LHCP incident light.

In the embodiment shown in FIGS. 8A and 8B, for the LHCP incident light 802, the LC device 800 is configured to operate in the absorption state when the voltage supplied by the power source 730 is lower than or equal to the threshold voltage, and operate in the transmission state when the voltage is sufficiently higher than the threshold voltage. In addition, as the voltage gradually increases from the threshold voltage, for the LHCP incident light 802, the light transmittance of the LC device 800 may gradually increase. When the incident light 802 is an RHCP light, the LC device 800 may operate in the transmission state at both of the voltage-off state and the voltage-on state.

Although not shown, in some embodiments, when the incident light 802 is an RHCP light, the LC device 800 is configured to operate in the absorption state when the voltage supplied by the power source 730 is lower than or equal to the threshold voltage, and operate in the transmission state when the voltage is sufficiently higher than the threshold voltage. When the incident light 802 is an LHCP light, the LC device 800 may operate in the transmission state at both of the voltage-off state and the voltage-on state.

In some embodiments, by configuring the initial orientations of the LC molecules 415 differently (e.g., via configuring the alignment layers 305), the LC device 800 may be configured to operate in the absorption state when the voltage is sufficiently higher than the threshold voltage, and operate in the transmission state when the voltage is lower than or equal to the threshold voltage. For example, the LC device 800 may be configured to operate in the absorption state for an LHCP light, when the voltage is sufficiently higher than the threshold voltage, and operate in the transmission state for the LHCP light, when the voltage is lower than or equal to the threshold voltage. In some embodiments, the LC device 800 may be configured to operate in the absorption state for an RHCP light, when the voltage is sufficiently higher than the threshold voltage, and operate in the transmission state for the RHCP light, when the voltage is lower than or equal to the threshold voltage.

For discussion purposes, FIGS. 4A and 4B and FIGS. 7A-8B show that the LC layer 405 or 435 includes calamitic LC molecules 415 or 440 arranged in a helical structure having a constant helix pitch. In some embodiments, the LC layer 405 or 435 may include calamitic LC molecules arranged in a helical structure having a varying helix pitch. In some embodiments, the LC layer 405 or 435 may include discotic LC molecules arranged in a helical structure having a constant helix pitch. In some embodiments, the LC layer 405 or 435 may include discotic LC molecules arranged in a helical structure having a varying helix pitch. For discussion purposes, FIG. 4B and FIGS. 7A-7B show the molecular helix of the supramolecules 447 of the chiral dopants 445 rotate in a predetermined direction (e.g., a clockwise direction or a counter-clockwise direction), along the axial direction, with a constant helix pitch. In some embodiments, the molecular helix of the supramolecules 447 of the chiral dopants 445 may rotate in a predetermined direction (e.g., a clockwise direction or a counter-clockwise direction), along the axial direction, with a varying helix pitch.

For discussion purposes, FIGS. 4A and 4B and FIGS. 7A-8B show that the disclosed LC device 400, 430, 700, or 800 includes a single LC layer 405 or 435. In some embodiments, the disclosed LC device 400, 430, 700, or 800 may include any other suitable number of CLC layers, such as two, three, four, or five, etc., each of which may include calamitic and/or discotic LC materials configured with a helical structure of a varying or constant helix pitch. When the CLC layer includes the supramolecules 447 of the chiral dopants 445, the molecular helix of the supramolecules 447 of the chiral dopants 445 may rotate in a predetermined direction (e.g., a clockwise direction or a counter-clockwise direction), along the axial direction, with a constant or varying helix pitch.

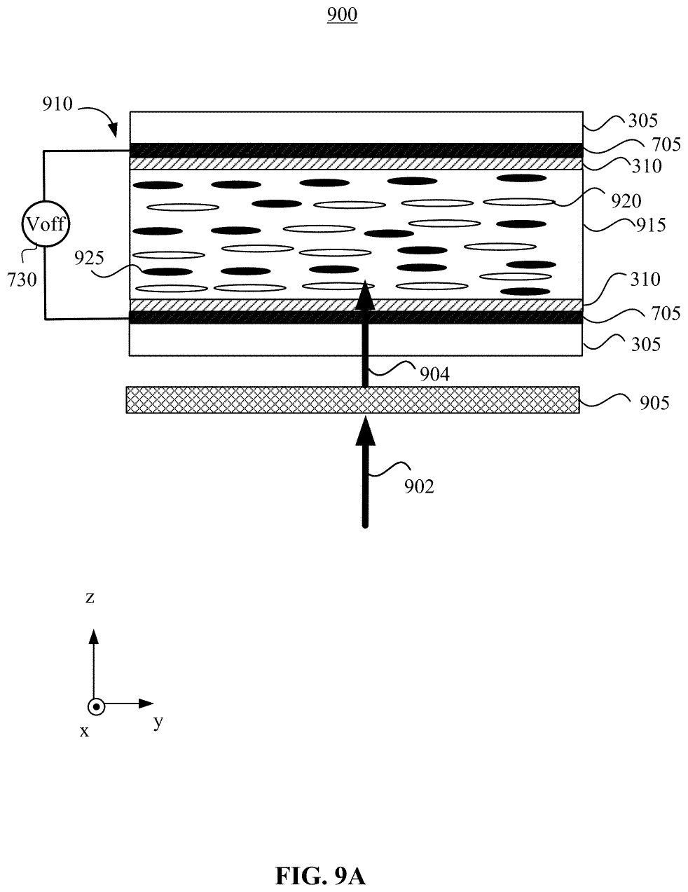

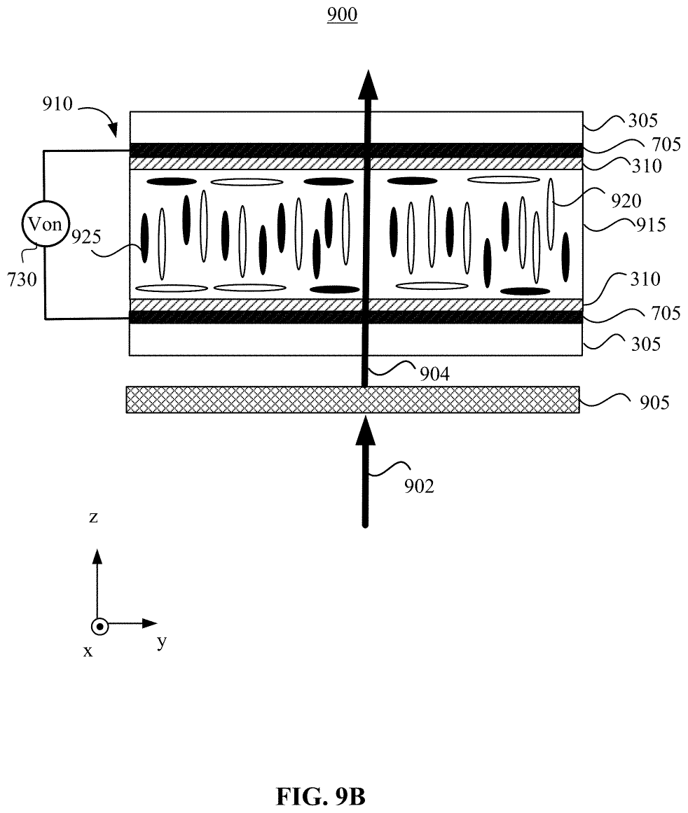

FIG. 9A schematically illustrates a y-z sectional view of an LC device 900 operating at a voltage-off state, according to an embodiment of the present disclosure. FIG. 9B schematically illustrates a y-z sectional view of the LC device 900 operating at a voltage-on state, according to an embodiment of the present disclosure. The LC device 900 may function as a switchable optical shutter that is circular polarization selective. The LC device 900 may include elements that are the same as or similar to those included in the LC device 200 shown in FIG. 2A, the LC device 230 shown in FIG. 2B, the LC device 250 shown in FIG. 2C, the LC device 400 shown in FIG. 4A, the LC device 430 shown in FIG. 4B, the LC device 700 shown in FIGS. 7A and 7B, or the LC device 800 shown in FIGS. 8A and 8B. Descriptions of the similar elements may refer to the above descriptions rendered in connection with FIGS. 2A-2C, FIGS. 3A-3D, FIGS. 4A and 4B, FIGS. 7A and 7B, or FIGS. 8A and 8B.

As shown in FIG. 9A, the LC device 900 may include a waveplate 905 and an LC cell 910 stacked together. A circularly polarized light 902 having a predetermined handedness may be incident onto the LC device 900 from the side of the waveplate 905. The waveplate 910 may be configured to convert the circularly polarized light 902 into a linearly polarized light 904 having a predetermined polarization direction. The linearly polarized light 904 having the predetermined polarization direction may propagate toward the LC cell 910. In some embodiments, the waveplate 910 may function as a broadband and wide angle quarter-wave plate (“QWP”) configured to provide a quarter-wave birefringence (or quarter-wave phase retardance) across a wide spectral range (or wavelength range) (e.g., visible spectrum) to the linearly polarized light. In some embodiments, for an achromatic design, the waveplate 910 may include a multi-layer birefringent material (e.g., a polymer or liquid crystals) configured to provide a quarter-wave birefringence (or quarter-wave phase retardance) across a wide spectral range (or wavelength range) (e.g., visible spectrum).

The LC cell 910 may be a switchable optical shutter that is linear polarization selective. The LC cell 910 may be switchable between operating in an absorption state and operating in a transmission state. The LC cell 910 operating in the absorption state may be configured to substantially block a linearly polarized light having the predetermined polarization direction via absorption, and substantially transmit a linearly polarized light having a polarization direction that is orthogonal to the predetermined polarization direction. Thus, the LC cell 910 operating in the absorption state may substantially block the linearly polarized light 904 having the predetermined polarization direction. Accordingly, the LC device 900 may operate in an absorption state for the circularly polarized light 902 having the predetermined handedness. The LC cell 910 operating in the transmission state may be configured to substantially transmit a linearly polarized light via absorption, independent of the polarization direction of the linearly polarized light.

The LC cell 910 may include two substates 305, the alignment layers 310, and an LC layer 915 disposed between the two substates 305. The LC cell 910 may also include two electrodes 705 coupled to the LC layer 915. The electrodes 705 may be configured to apply a driving voltage provided by the power source 730 to the LC layer 915, thereby tuning the light transmittance of the LC cell 910. In some embodiments, the two electrodes 705 may be disposed at different substrates 305. In some embodiments, the two electrodes 705 may be disposed at the same substrate (e.g., at the upper or the lower substrate 305), and an electrical insulating layer may be disposed between the two electrodes 705. Each electrode 705 may be a continuous planar electrode, a patterned planar electrode, or a protrusion electrode. For discussion purposes, FIG. 9A shows that the two electrodes 705 are planar electrodes disposed at different substrates 305, and disposed between the respective alignment layers 310 and the substrates 305.

In some embodiments, the LC layer 915 may be a guest-host LC layer that includes a mixture of host LCs 920 and guest dyes 925 doped into the host LCs 920. In some embodiments, the host LCs 920 may have positive dielectric anisotropy (Δε>0) or negative dielectric anisotropy (Δε<0). In some embodiments, the host LCs 920 may include dual-frequency LCs, whose dielectric constant may be tunable through tunning the frequency of an electric field applied to the LC layer 915. The alignment layers 310 may be configured to homeotropically or homogeneously align the LC molecules of the host LCs 920. Dye molecules of the guest dyes 925 may be aligned together with the molecules of the host LCs 920 to have substantially the same orientation. In some embodiments, the guest dyes 925 may include dichroic dyes exhibiting an anisotropic linear absorption. The dichroic dyes 925 may have an absorption axis that is in a long axis or short axis of the dye molecules. For example, positive dichroic dyes may have an absorption axis that is in a long axis of the dye molecules, and negative dichroic dyes may have an absorption axis that is in a short axis of the dye molecules. In some embodiments, the dichroic dyes 925 may strongly absorb an incident light polarized (or having an E-field) in a direction parallel to an absorption axis of the dye molecules, and weakly absorb an incident light polarized (or having an E-field) in a direction perpendicular to the absorption axis of the dye molecules. In some embodiments, the dichroic dyes 925 may substantially absorb an incident light polarized (or having an E-field) in a direction parallel to an absorption axis of the dye molecules, and substantially transmit an incident light polarized (or having an E-field) in a direction perpendicular to the absorption axis of the dye molecules.

For illustrative purpose, FIG. 9A shows that the dichroic dyes 925 are positive dichroic dyes having the absorption axis in the long axis of the dye molecules. The alignment layers 310 may be configured to provide anti-parallel alignments to the LC molecules, and the LC molecules may be homogeneously aligned (e.g., in a y-axis direction in FIG. 9A). The dye molecules may be aligned together with the LC molecules, e.g., homogeneously aligned. The host LCs 920 may include active LCs. When the orientations of the LC molecules are changed via an external electric field generated between the electrodes 705, the orientations of the dye molecules may also change with the LC molecules. As a result, the orientation of the absorption axis of the dichroic dyes 925 may be changed. Thus, the light transmittance of the LC cell 910 may be modulated by rotating the dye molecules within a voltage-controllable LC cell.

As shown in FIG. 9A, when a voltage applied to the LC cell 910 is lower than or equal to a threshold voltage of the LC cell 910 (e.g., when the power source 730 supplies a substantially zero voltage), the LC molecules and the dye molecules may be homogeneously aligned in the y-axis direction. The absorption axis of the dichroic dyes 925 or the long axes of the dye molecules may be configured in the y-axis direction. Thus, the dichroic dyes 925 may strongly absorb a linearly polarized light polarized in the y-axis direction, and weakly absorb a linearly polarized light polarized in the x-axis direction. Accordingly, the LC cell 910 may strongly absorb a linearly polarized light polarized in the y-axis direction, and weakly absorb a linearly polarized light polarized in the x-axis direction.

For discussion purposes, the circularly polarized light 902 having the predetermined handedness may be an RHCP light, and the waveplate 905 may be configured to convert the circularly polarized light (e.g., RHCP light) 902 into the linearly polarized light 904 polarized in the y-axis direction (e.g., a p-polarized light). Thus, the linearly polarized light (e.g., p-polarized light) 904 may be substantially absorbed by the LC cell 910. In other words, at the voltage-off state, the LC cell 910 may operate in the absorption state for the linearly polarized light (e.g., p-polarized light) 904. Accordingly, at the voltage-off state, the LC device 900 may operate in the absorption state for the circularly polarized light (e.g., RHCP light) 902.

As shown in FIG. 9B, when a voltage is supplied to the LC cell 910, an electric field (e.g., along a z-axis direction) may be generated between the two opposite substrates 305. When the voltage is higher than the threshold voltage and is gradually increased, the LC molecules of the host LCs 920 may trend to be reoriented by the electric field (e.g., may gradually become oriented parallel with the electric field direction). The dye molecules of the guest dyes 925 may be reoriented with the LC molecules at the voltage-on state. When the voltage is sufficiently high, as shown in FIG. 9B, the LC molecules may be reoriented to be parallel with the electric field direction (e.g., z-axis direction). Accordingly, the dye molecules may be reoriented with the LC molecules to be parallel with the electric field direction (e.g., z-axis direction). The absorption axis of the dichroic dyes 925 or the long axes of the dye molecules may be reoriented to be in the electric field direction (e.g., z-axis direction). Thus, the dichroic dyes 925 may weakly absorb a linearly polarized light, independent of the polarization direction. In some embodiments, the dichroic dyes 925 may be configured to substantially transmit a linearly polarized light, independent of the polarization direction of the light. Accordingly, the LC cell 910 may substantially transmit a linearly polarized light, independent of the polarization direction of the light. As shown in FIG. 9B, the linearly polarized light (e.g., p-polarized light) 904 may be substantially transmitted through the LC cell 910. In other words, at the voltage-on state, the LC cell 910 may operate in the transmission state for the linearly polarized light (e.g., p-polarized light) 904. Accordingly, at the voltage-on state, the LC device 900 may operate in the transmission state for the circularly polarized light (e.g., RHCP light) 902.

In the embodiment shown in FIGS. 9A and 9B, for the circularly polarized light (e.g., RHCP light) 902, the LC device 900 is configured to operate in the absorption state when the voltage supplied by the power source 730 is lower than or equal to the threshold voltage, and operate in the transmission state when the voltage is sufficiently higher than the threshold voltage. In some embodiments, the LC device 900 may be configured to operate in the absorption state for an RHCP light when the voltage supplied by the power source 730 is lower than or equal to the threshold voltage, and operate in the transmission state for an RHCP light when the voltage is sufficiently higher than the threshold voltage.

In some embodiments, by configuring the initial orientations of the LC molecules of the host LCs 920 differently (e.g., via configuring the alignment layers 305), for the circularly polarized light (e.g., RHCP light) 902, the LC device 900 may be configured to operate in the transmission state when the voltage supplied by the power source 730 is lower than or equal to the threshold voltage, and operate in the absorption state when the voltage is sufficiently higher than the threshold voltage. In some embodiments, the LC device 900 may be configured to operate in the transmission state for an RHCP light when the voltage supplied by the power source 730 is lower than or equal to the threshold voltage, and operate in the absorption state for an RHCP light when the voltage is sufficiently higher than the threshold voltage.

The LC devices disclosed herein may have numerous applications in a large variety of fields, e.g., near-eye displays (“NEDs”), head-up displays (“HUDs”), head-mounted displays (“HMDs”), smart phones, laptops, televisions, vehicles, etc., which are all within the scope of the present disclosure. For example, the LC devices disclosed herein may be used as polarization management components, brightness enhancement components, display resolution enhancement components, optical path-folding components, eye-tracking components, accommodation components for multiple focus or variable focus, pupil steering elements, etc. Some exemplary applications in augmented reality (“AR”), virtual reality (“VR”), mixed reality (“MR)” fields or some combinations thereof will be explained below. Near-eye displays (“NEDs”) have been widely used in a large variety of applications, such as aviation, engineering, science, medicine, computer gaming, video, sports, training, and simulations. One application of NEDs is to realize VR, AR, MR or some combination thereof. Desirable characteristics of NEDs include compactness, light weight, high resolution, large field of view (“FOV”), and small form factor. An NED may include a display element configured to generate an image light and a lens system configured to direct the image light toward eyes of a user. The lens system may include a plurality of optical elements, such as lenses, waveplates, reflectors, etc., for focusing the image light to the eyes of the user. To achieve a compact size and light weight and to maintain satisfactory optical characteristics, an NED may adopt a pancake lens assembly in the lens system to fold the optical path, thereby reducing a back focal distance in the NED.

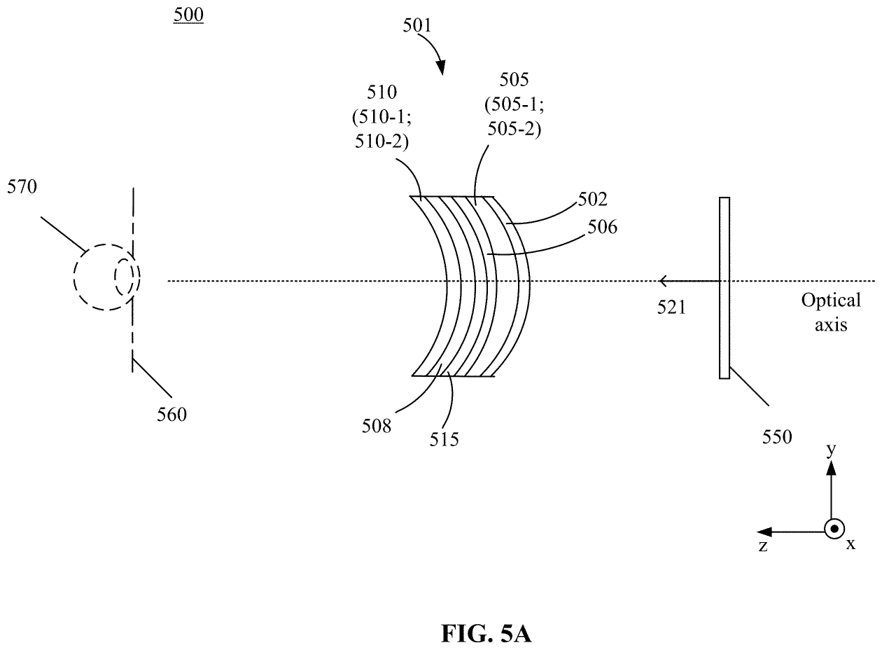

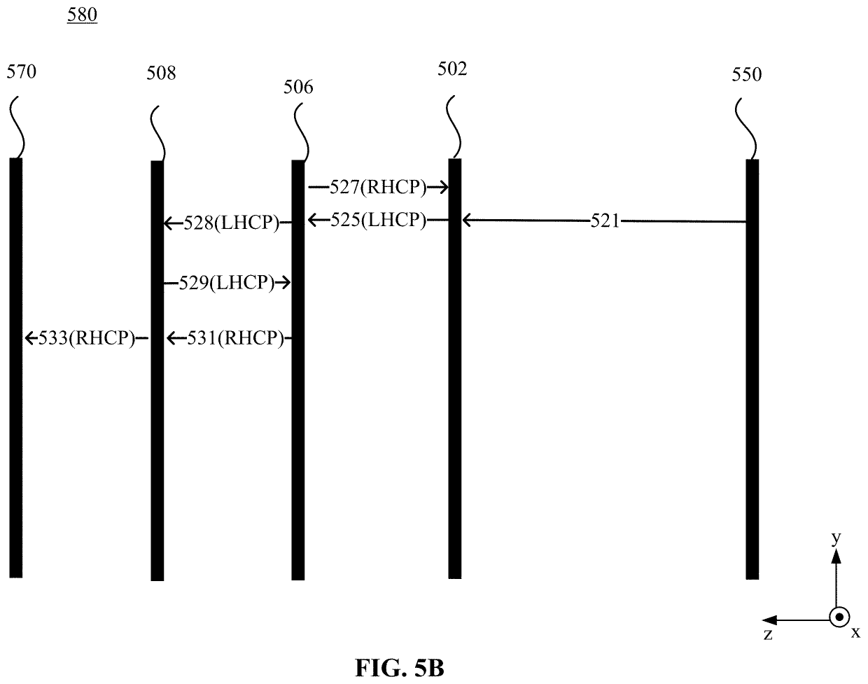

FIG. 5A illustrates a schematic diagram of an optical system 500 according to an embodiment of the present disclosure. The optical system 500 may include a pancake lens assembly 501 according to an embodiment of the present disclosure. The pancake lens assembly 501 may be implemented in an NED to fold the optical path, thereby reducing the back focal distance in the NED. The pancake lens assembly 501 may include one or more LC devices disclosed herein. As shown in FIG. 5A, the pancake lens assembly 501 may focus a light 521 emitted from an electronic display 550 (which may be other suitable light source) to an eye-box located at an exit pupil 560. Hereinafter, the light 521 emitted by the electronic display 550 for forming images is also referred to as an “image light.” The exit pupil 560 may be at a location where an eye 570 is positioned in an eye-box region when a user wears the NED. In some embodiments, the electronic display 550 may be a monochromatic display that includes a narrowband monochromatic light source (e.g., a light source having a 30 nm bandwidth). In some embodiments, the electronic display 550 may be a polychromatic display (e.g., a red-green-blue (“RGB”) display) that includes a broadband polychromatic light source (e.g., a light source having a 300 nm bandwidth covering the visible wavelength range). In some embodiments, the electronic display 550 may be a polychromatic display (e.g., an RGB display) including a stack of a plurality of monochromatic displays, which may include corresponding narrowband monochromatic light sources respectively.

In some embodiments, the pancake lens assembly 501 may include a first optical element 505 and a second optical element 510. In some embodiments, the pancake lens assembly 501 may be configured as a monolithic pancake lens assembly without any air gaps between optical elements included in the pancake lens assembly. In some embodiments, one or more surfaces of the first optical element 505 and the second optical element 510 may be shaped (e.g., curved) to compensate for field curvature. In some embodiments, one or more surfaces of the first optical element 505 and/or the second optical element 510 may be shaped to be spherically concave (e.g., a portion of a sphere), spherically convex, a rotationally symmetric asphere, a freeform shape, or some other shape that can mitigate field curvature. In some embodiments, the shape of one or more surfaces of the first optical element 505 and/or the second optical element 510 may be designed to additionally compensate for other forms of optical aberration. In some embodiments, the one or more LC devices disclosed herein may be formed on one or more curved surfaces of at least one of the first optical element 505 or the second optical element 510.

In some embodiments, one or more of the optical elements within the pancake lens assembly 501 may have one or more coatings, such as an anti-reflective coating, to reduce ghost images and enhance contrast. In some embodiments, the first optical element 505 and the second optical element 510 may be coupled together by an adhesive 515. Each of the first optical element 505 and the second optical element 510 may include one or more optical lenses. In some embodiments, at least one of the first optical element 505 or the second optical element 510 may have at least one flat surface. In some embodiments, the one or more LC devices disclosed herein may be formed on the flat surface(s) of at least one of the first optical element 505 or the second optical element 510.

The first optical element 505 may include a first surface 505-1 facing the electronic display 550 and an opposing second surface 505-2 facing the eye 570. The first optical element 505 may be configured to receive an image light at the first surface 505-1 from the electronic display 550 and output an image light with an altered property at the second surface 505-2. The pancake lens assembly 501 may also include a circular absorptive polarizer 502 and a mirror 506 arranged in an optical series, each of which may be an individual layer, film, or coating disposed at (e.g., bonded to or formed at) the first optical element 505. The circular absorptive polarizer 502 and the mirror 506 may be disposed at (e.g., bonded to or formed at) the first surface 505-1 or the second surface 505-2 of the first optical element 505.

For discussion purposes, FIG. 5A shows that the circular absorptive polarizer 502 is disposed at (e.g., bonded to or formed at) the first surface 505-1, and the mirror 506 is disposed at (e.g., bonded to or formed at) the second surface 505-2. Other arrangements are also contemplated. In some embodiments, the circular absorptive polarizer 502 may be any embodiment of the LC circular absorptive polarizer disclosed herein, such as the LC device 400 shown in FIG. 4A, the LC device 430 shown in FIG. 4B, the LC device 700 shown in FIGS. 7A and 7B, the LC device 800 shown in FIGS. 8A and 8B, or the LC device 900 shown in FIGS. 9A and 9B. In some embodiments, the circular absorptive polarizer 502 may be configured to operate at a visible spectrum. In some embodiments, the mirror 506 may be a partial reflector that is partially reflective to reflect a portion of a received light. In some embodiments, the mirror 506 may be configured to transmit about 50% and reflect about 50% of a received light, and may be referred to as a “50/50 mirror.”

The second optical element 510 may have a first surface 510-1 facing the first optical element 505 and an opposing second surface 510-2 facing the eye 570. The pancake lens assembly 501 may also include a circular reflective polarizer 508, which may be an individual layer, film, or coating disposed at (e.g., bonded to or formed at) the second optical element 510. The circular reflective polarizer 508 may be disposed at (e.g., bonded to or formed at) the first surface 510-1 or the second surface 510-2 of the second optical element 510 and may receive a light output from the mirror 506. For discussion purposes, FIG. 5A shows that the circular reflective polarizer 508 is disposed at (e.g., bonded to or formed at) the first surface 510-1 of the second optical element 510. That is, the circular reflective polarizer 508 may be disposed between the first optical element 505 and the second optical element 510. In some embodiments, the circular reflective polarizer 508 may be disposed at the second surface 510-2 of the second optical element 510. The circular reflective polarizer 508 may be any embodiment of the LC circular reflective polarizer disclosed herein, such as the CLC reflective polarizer 200 shown in FIG. 2A, the CLC reflective polarizer 230 shown in FIG. 2B, or the CLC reflective polarizer 250 shown in FIG. 2C. The circular reflective polarizer 508 may exhibit an ultra-low light leakage. Accordingly, the optical performance and reliability of the pancake lens assembly 501 may be significantly improved.

The pancake lens assembly 501 shown in FIG. 5A is merely for illustrative purposes. In some embodiments, one or more of the first surface 505-1 and the second surface 505-2 of the first optical element 505 and the first surface 510-1 and the second surface 510-2 of the second optical element 510 may be curved surface(s) or flat surface(s). In some embodiments, the pancake lens assembly 501 may have one optical element or more than two optical elements.

FIG. 5B illustrates a schematic cross-sectional view of an optical path 580 of a light propagating in the pancake lens assembly 501 shown in FIG. 5A, according to an embodiment of the present disclosure. In the light propagation path 580, the change of polarization of the light is shown. Thus, the first optical element 505 and the second optical element 510, which are presumed to be lenses that do not affect the polarization of the light, are omitted for the simplicity of illustration. In FIG. 5B, “RHCP” and “LHCP” denote right-handed circularly polarized light and left-handed circularly polarized light, respectively. For discussion purposes, as shown in FIG. 5B, the circular absorptive polarizer 502 may be configured to substantially transmit an LHCP light and substantially block an RHCP light via absorption. The circular reflective polarizer 508 may be a left-handed CLC reflective polarizer. For illustrative purposes, the electronic display 550, the circular absorptive polarizer 502, the mirror 506, and the circular reflective polarizer 508 are illustrated as flat surfaces in FIG. 5B. In some embodiments, one or more of the electronic display 550, the circular absorptive polarizer 502, the mirror 506, and the circular reflective polarizer 508 may include a curved surface.

As shown in FIG. 5B, the electronic display 550 may generate the unpolarized image light 521 covering a predetermined spectrum, such as a portion of the visible spectral range or substantially the entire visible spectral range. The circular absorptive polarizer 502 may transmit the unpolarized image light 521 as an LHCP light 525 toward the mirror 506. In some embodiments, the image light 521 may be a circularly polarized light, and the circular absorptive polarizer 502 may be omitted. The mirror 506 may reflect a first portion of the LHCP light 525 as an RHCP light 527 toward the circular absorptive polarizer 502, and transmit a second portion of the LHCP light 525 as an LHCP light 528 toward the CLC circular reflective polarizer 508. As the circular reflective polarizer 508 is a left-handed CLC reflective polarizer, the circular reflective polarizer 508 may reflect the LHCP light 528 as an LHCP light 529 back toward the mirror 506. The mirror 506 may reflect the LHCP light 529 as an RHCP light 531, which may be transmitted through the circular reflective polarizer 508 as an RHCP light 533. The RHCP light 533 may be focused onto the eye 570.

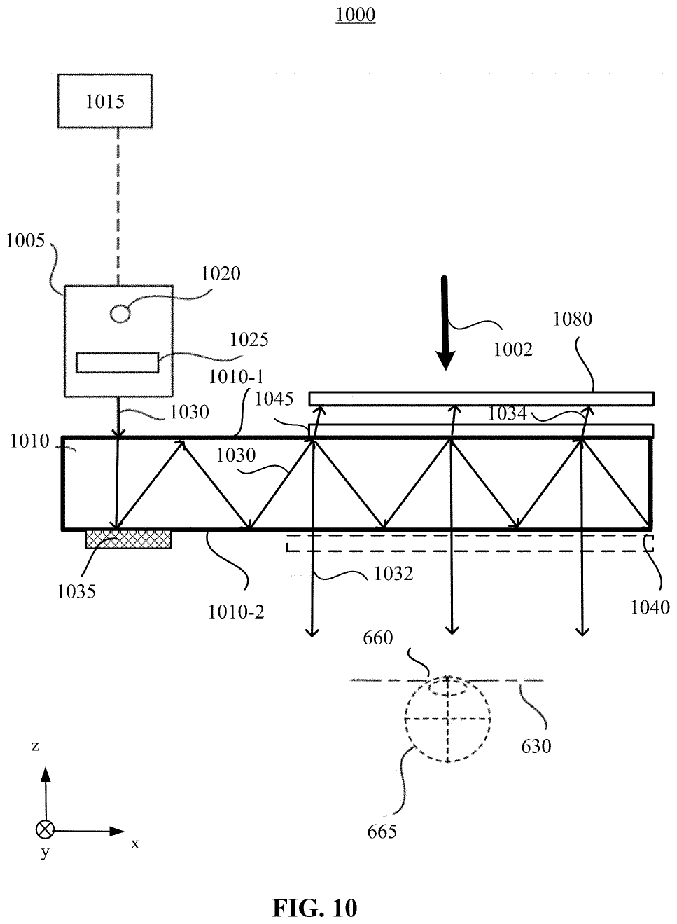

Pupil-replication (or pupil-expansion) light guide display systems have been implemented in various devices for VR, AR, and/or MR applications, such NEDs, HMDs, or HUDs, etc., which can potentially offer eye-glasses form factors, a moderately large field of view (“FOV”), a high transmittance, and a large eye-box. FIG. 10 illustrates a schematic diagram of a light guide (or waveguide) display system 1000, according to an embodiment of the present disclosure. The light guide display system 1000 may provide pupil-replication (or pupil-expansion). The light guide display system 1000 may be implemented in NEDs for VR, AR, and/or MR applications. The light guide display system 1000 may include one or more disclosed LC polarizers.

As shown in FIG. 10, the light guide display system 1000 may include a light source assembly 1005, a light guide 1010, and a controller 1015. The controller 1015 may be configured to perform various controls, adjustments, or other functions or processes described herein. The light source assembly 1005 may include a light source 1020 and an light conditioning system 1025. In some embodiments, the light source 1020 may be a light source configured to generate a coherent or partially coherent light. The light source 1020 may include, e.g., a laser diode, a vertical cavity surface emitting laser, a light emitting diode, or a combination thereof. In some embodiments, the light source 1020 may be a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the light source 1020 may be a self-emissive panel, such as an OLED display panel or a micro-LED display panel. In some embodiments, the light source 1020 may be a display panel that is illuminated by an external source, such as an LCD panel, an LCoS display panel, or a DLP display panel. Examples of an external source may include a laser, an LED, an OLED, or a combination thereof. The light conditioning system 1025 may include one or more optical components configured to condition the light from the light source 1020. For example, the controller 1015 may control the light conditioning system 1025 to condition the light from the light source 1020, which may include, e.g., transmitting, attenuating, expanding, collimating, and/or adjusting orientation of the light.

The light source assembly 1005 may generate an image light 1030 and output the image light 1030 to an in-coupling element 1035 disposed at a first portion of the light guide 1010. The light guide 1010 may expand and direct the image light 1030 to an eye 665 positioned in an eye-box 630 of the light guide display system 1000. An exit pupil 660 may be a location where the eye 665 is positioned in the eye-box 630. The in-coupling element 1035 located at the first portion of the light guide 1010 may receive the image light 1030, and couple the image light 1030 into a total internal reflection (“TIR”) path inside the light guide 1010. The image light 1030 may propagate inside the light guide 1010 through TIR along the TIR path, toward an out-coupling element 1045 located at a second portion of the light guide 1010. The first portion and the second portion may be located at different portions of the light guide 1010. The out-coupling element 1045 may be configured to couple the image light 1030 out of the light guide 1010 toward the eye 665.

The light guide 1010 may include a first surface or side 1010-1 facing the real-world environment and an opposing second surface or side 1010-2 facing the eye 665. Each of the in-coupling element 1035 and the out-coupling element 1045 may be disposed at the first surface 1010-1 or the second surface 1010-2 of the light guide 1010. In some embodiments, as shown in FIG. 10, the in-coupling element 1035 may be disposed at the second surface 1010-2 of the light guide 1010, and the out-coupling element 1045 may be disposed at the first surface 1010-1 of the light guide 1010. In some embodiments, the in-coupling element 1035 may be disposed at the first surface 1010-1 of the light guide 1010. In some embodiments, the out-coupling element 1045 may be disposed at the second surface 1010-2 of the light guide 1010. In some embodiments, both of the in-coupling element 1035 and the out-coupling element 1045 may be disposed at the first surface 1010-1 or the second surface 1010-2 of the light guide 1010. In some embodiments, the in-coupling element 1035 or the out-coupling element 1045 may be integrally formed as a part of the light guide 1010 at the corresponding surface. In some embodiments, the in-coupling element 1035 or the out-coupling element 1045 may be separately formed, and may be disposed at (e.g., affixed to) the corresponding surface.

In some embodiments, each of the in-coupling element 1035 and the out-coupling element 1045 may include one or more diffraction gratings, one or more cascaded reflectors, one or more prismatic surface elements, and/or an array of holographic reflectors, or any combination thereof. In some embodiments, each of the in-coupling element 1035 and the out-coupling element 1045 may include one or more diffraction gratings, such as a surface relief grating, a volume hologram, a polarization selective grating, a polarization volume hologram (“PVH”), a metasurface grating, another type of diffractive element, or any combination thereof. In some embodiments, a period of the diffraction grating included in the in-coupling element 1035 may be configured to enable TIR of the image light 1030 within the light guide 1010. In some embodiments, a period of the diffraction grating included in the out-coupling element 1045 may be configured to couple the image light 1030 that has been propagated inside the light guide 1010 through TIR out of the light guide 1010 via diffraction.

The light guide 1010 may include one or more materials configured to facilitate the total internal reflection of the image light 1030. The light guide 1010 may include, for example, a plastic, a glass, and/or polymers. The controller 1015 may be communicatively coupled with the light source assembly 1005, and may control the operations of the light source assembly 1005. In some embodiments, the light guide 1010 may output the expanded image light 1030 to the eye 665 with an increased or expanded field of view (“FOV”). The light guide 1010 coupled with the in-coupling element 1035 and the out-coupling element 1045 may also function as an image combiner (e.g., AR or MR combiner). The light guide 1010 may combine the image light 1030 representing a virtual image and a light 1002 from the real world environment (or a real world light 1002), such that the virtual image generated by the light source assembly 1005 may be superimposed with real-world images or see-through images. With the light guide display assembly 1000, the physical display and electronics may be moved to a side of a front body of an NED. A substantially fully unobstructed view of the real world environment may be achieved, which enhances the AR or MR user experience.

In some embodiments, the light guide 1010 may include additional elements configured to redirect, fold, and/or expand the pupil of the light source assembly 1005. For example, as shown in FIG. 10, the light guide 1010 may include a redirecting element 1040 configured to redirect the received input image light 1030 to the out-coupling element 1045, such that the received input image light 1030 is coupled out of the light guide 1010 via the out-coupling element 1045. In some embodiments, the redirecting element 1040 may be arranged at a location of the light guide 1010 opposing the location of the out-coupling element 1045. In some embodiments, the redirecting element 1040 may be disposed at the second surface 1010-2 of the light guide 1010. For example, in some embodiments, the redirecting element 1040 may be integrally formed as a part of the light guide 1010 at the second surface 1010-2. In some embodiments, the redirecting element 1040 may be separately formed and disposed at (e.g., affixed to) the second surface 1010-2 of the light guide 1010. In some embodiments, the redirecting element 1040 may be disposed at the first surface 1010-1 of the light guide 1010. For example, in some embodiments, the redirecting element 1040 may be integrally formed as a part of the light guide 1010 at the first surface 1010-1. In some embodiments, the redirecting element 1040 may be separately formed and disposed at (e.g., affixed to) the first surface 1010-1 of the light guide 1010.

In some embodiments, the redirecting element 1040 and the out-coupling element 1045 may have a similar structure. In some embodiments, the redirecting element 1040 may include one or more diffraction gratings, one or more cascaded reflectors, one or more prismatic surface elements, and/or an array of holographic reflectors, or any combination thereof. In some embodiments, the redirecting element 1040 may include one or more diffraction gratings, such as a surface relief grating, a volume hologram, a polarization selective grating, a polarization volume hologram, a metasurface grating, another type of diffractive element, or any combination thereof. In some embodiments, multiple functions, e.g., redirecting, folding, and/or expanding the pupil of the light generated by the light source assembly 1005 may be combined into a single element, e.g. the out-coupling element 1045.

In some embodiments, the light guide display system 1000 may include a plurality of light guides 1010 disposed in a stacked configuration (not shown in FIG. 10). At least one (e.g., each) of the plurality of light guides 1010 may be coupled with or include one or more diffractive elements (e.g., in-coupling element, out-coupling element, and/or directing element), which may be configured to direct the image light 1030 toward the eye 665. In some embodiments, the plurality of light guides 1010 disposed in the stacked configuration may be configured to output an expanded polychromatic image light (e.g., a full-color image light). In some embodiments, the light guide display system 1000 may include one or more light source assemblies 1005 and/or one or more light guides 1010. In some embodiments, at least one (e.g., each) of the light source assemblies 1005 may be configured to emit a monochromatic image light of a specific wavelength band corresponding to a primary color (e.g., red, green, or blue) and a predetermined FOV (or a predetermined portion of an FOV). In some embodiments, the light guide display system 1000 may include three different light guides 1010 configured to deliver component color images (e.g., primary color images) by in-coupling and subsequently out-coupling, e.g., red, green, and blue lights, respectively, in any suitable order. In some embodiments, the light guide display assembly 1000 may include two different light guides configured to deliver component color images (e.g., primary color images) by in-coupling and subsequently out-coupling, e.g., a combination of red and green lights, and a combination of green and blue lights, respectively, in any suitable order. In some embodiments, at least one (e.g., each) of the light source assemblies 1005 may be configured to emit a polychromatic image light (e.g., a full-color image light). The relative positions of the eye 665 and the light source assembly 1005 shown in FIG. 10 are for illustrative purposes, in some embodiments, the eye 665 and the light source assembly 1005 may be disposed at the same side of the light guide 1010.

In some embodiments, the light guide display system 1000 may include an LC device 1080 disposed at the second portion of the light guide 1010, and at a side of the light guide 1010 facing the real world environment. In the embodiment shown in FIG. 10, the LC device 1080 and the out-coupling element 1045 may be disposed at the same side or surface of the light guide 1010, e.g., the first side 1010-1 of the light guide 1010. The out-coupling element 1045 may be disposed between the LC device 1080 and the light guide 1010. FIG. 10 shows that the LC device 1080 is spaced apart from the out-coupling element 1045 by a gap. In some embodiments, the LC device 1080 and the out-coupling element 1045 may be stacked without a gap. In the embodiment shown in FIG. 10, when the image light 1030 is incident onto the out-coupling element 1045, the out-coupling element 1045 may be configured to backwardly deflect a first portion of the image light 1030 (propagating inside the light guide 1010 via TIR) as an image light 1032 propagating toward the eye 665, and forwardly deflect a second portion of the image light 1030 (propagating inside the light guide 1010 via TIR) as an image light 1034 propagating toward the LC device 1080. The LC device 1080 may be configured to substantially block the image light 1034 via absorption, such that the image light 1034 may not propagate toward the real world environment. Thus, when the light guide 1010 functions as an AR or MR combiner, other people (other than the user of the light guide display system 1000) may not perceive the virtual image that is generated by the light source assembly 1005 and perceived by the eye 665 of the user, thereby enhancing the privacy of AR or MR devices implemented with the light guide display system 1000.

In some embodiments, the out-coupling element 1045 and the in-coupling 1035 may be polarization selective components, e.g., circular polarization selective components. The LC device 1080 may be any embodiment of the disclosed LC devices configured to selectively absorb or transmit a circularly polarized light, depending on the handedness of the circularly polarized light. For example, the LC device 1080 may be an embodiment of the LC device 400 shown in FIG. 4A, the LC device 430 shown in FIG. 4B, the LC device 700 shown in FIGS. 7A and 7B, the LC device 800 shown in FIGS. 8A and 8B, or the LC device 900 shown in FIGS. 9A and 9B. When the LC device 1080 is an embodiment of the LC device 900 shown in FIGS. 9A and 9B, the waveplate 905 may be disposed between the out-coupling element 1045 and the LC cell 910.

For example, in some embodiments, the out-coupling element 1045 may include a polarization volume hologram element configured to substantially backwardly diffract a circular polarized light having a predetermined handedness (e.g., RHCP light), and substantially transmit a circular polarized light (e.g., LHCP light) having a handedness that is opposite to the predetermined handedness. For discussion purposes, the image light 1030 propagating inside the light guide 1010 may be an RHCP light. When the image light (e.g., RHCP light) 1030 is incident onto the out-coupling element 1045, the out-coupling element 1045 may be configured to backwardly diffract the image light (e.g., RHCP light) 1030 and output the image light (e.g., an RHCP light) 1032 toward the eye 665, and forward diffract the image light (e.g., RHCP light) 1030 and output the image light (e.g., an LHCP light) 1034 toward the LC device 1080. The LC device 1080 may be configured to substantially block an LHCP light via absorption, and substantially transmit an RHCP light. Thus, the image light (e.g., an LHCP light) 1034 transmitted by the out-coupling element 1045 via diffraction may be blocked by the LC device 1080 from being received by the other people (other than the user). For the light 1002 from the real world that is incident on the LC device 1080, the LC device 1080 may substantially block an LHCP component of the light 1002 via absorption, and substantially transmit an RHCP component of the light 1002.

In some embodiment, when the LC device 1080 is an embodiment of the LC device 700 shown in FIGS. 7A and 7B, the LC device 800 shown in FIGS. 8A and 8B, or the LC device 900 shown in FIGS. 9A and 9B, the controller 1015 may be configured to control the LC device 1080 to switch between operating in the absorption state and operating in the transmission state during a display frame of the light source 1020. In some embodiment, the display frame of the light source 1020 may be divided in two subframes for sequential transmission of lights from real and virtual worlds, respectively. The out-coupling element 1045 may be configured to decouple the image light 1030 out of the light guide 1010 during a virtual-world subframe of the display frame, and not decouple the image light 1030 out of the light guide 1010 during a real-world subframe of the display frame. In some embodiment, the controller 1015 may be configured to control the LC device 1080 to switch between operating in the absorption state during the virtual-world subframe of the display frame, and operating in the transmission state during a real-world subframe of the display frame. In some embodiments, the virtual-world subframe may have a shorter duration than the real-world subframe. Thus, the light transmittance of the light 1002 from the real world may be increased, and the brightness of the see-through view may be enhanced.

Although not shown, in some embodiments, the out-coupling element 1045 may be disposed at the second surface 1010-2 of the light guide 1010, and configured to forwardly deflect a first portion of the image light 1030 (propagating inside the light guide 1010 via TIR) as the image light 1032 propagating toward the eye 665, and backwardly deflect a second portion of the image light 1030 (propagating inside the light guide 1010 via TIR) as the image light 1034 propagating toward the LC device 1080. In such an embodiment, the LC device 1080 and the out-coupling element 1045 may be disposed at two different sides of the light guide 1010.

The configuration of the light guide display system 1000 shown in FIG. 10 is used as an example structure in illustrating and explaining the operation principles of using the LC device 900 to block the image light 1034 prorogating toward the real world environment and enhance the privacy of AR or MR devices implemented with the light guide display system 1000. The operations principles of using the LC device 900 to block the image light 1034 prorogating toward the real world environment and enhance the privacy of AR or MR devices implemented with the light guide display system 1000 may be applicable to any suitable display systems other than the disclosed light guide display system 1000. For example, in some embodiments, the display system may include an image combiner (e.g., AR or MR combiner) based on a holographic optical element, which may be configured to deflect an image light received from a light source assembly to an exit pupil. The LC device 1080 may be disposed at a side of the image combiner facing the real world environment. In some embodiments, the display system may include a lens assembly configured to focus an image light received from a light source assembly to an exit pupil. The LC device 1080 may be disposed at a side of the lens assembly facing the real world environment.

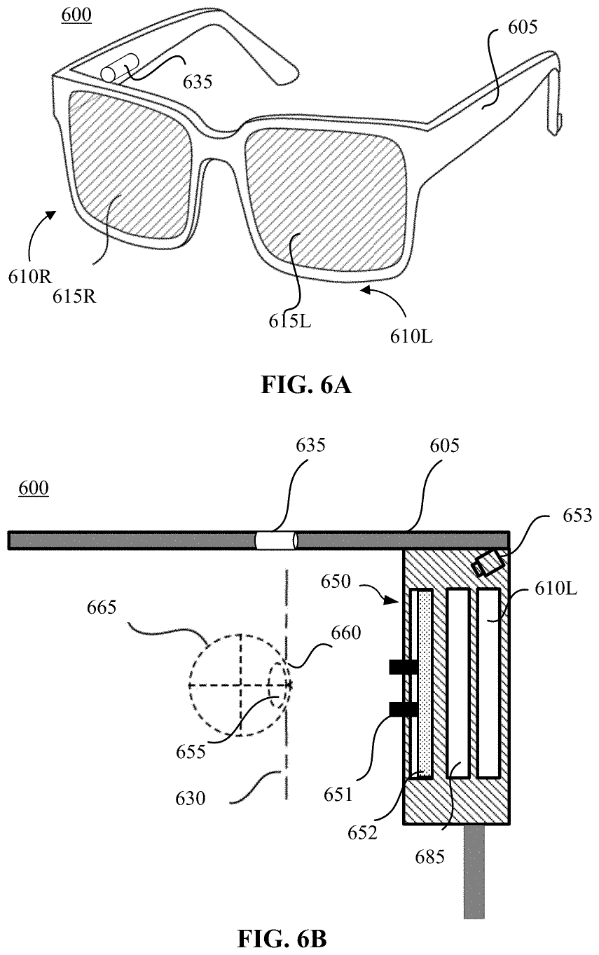

FIG. 6A illustrates a schematic diagram of a near-eye display (“NED”) 600 according to an embodiment of the disclosure. FIG. 6B is a cross-sectional view of half of the NED 600 shown in FIG. 6A according to an embodiment of the disclosure. For purposes of illustration, FIG. 6B shows the cross-sectional view associated with a left-eye display system 610L. The NED 600 may include a controller (not shown). The NED 600 may include a frame 605 configured to mount to a user's head. The frame 605 is merely an example structure to which various components of the NED 600 may be mounted. Other suitable fixtures may be used in place of or in combination with the frame 605. The NED 600 may include right-eye and left-eye display systems 610R and 610L mounted to the frame 605. The NED 600 may function as a VR device, an AR device, an MR device, or any combination thereof. In some embodiments, when the NED 600 functions as an AR or an MR device, the right-eye and left-eye display systems 610R and 610L may be entirely or partially transparent from the perspective of the user, which may provide the user with a view of a surrounding real-world environment. In some embodiments, when the NED 600 functions as a VR device, the right-eye and left-eye display systems 610R and 610L may be opaque, such that the user may be immersed in the VR imagery based on computer-generated images.

The right-eye and left-eye display systems 610R and 610L may include image display components configured to project computer-generated virtual images into left and right display windows 615L and 615R in a field of view (“FOV”). The right-eye and left-eye display systems 610R and 610L may be any suitable display systems. For illustrative purposes, FIG. 6A shows that the right-eye and left-eye display systems 610R and 610L may include a projector 635 coupled to the frame 605. The projector 635 may generate an image light representing a virtual image. In some embodiments, the right-eye and left-eye display systems 610R and 610L may include one or more LC devices disclosed herein. As shown in FIG. 6B, the NED 600 may also include a lens system (or viewing optical system) 685 and an object tracking system 650 (e.g., eye tracking system and/or face tracking system). The lens system 685 may be disposed between the object tracking system 650 and the left-eye display system 610L. The lens system 685 may be configured to guide the image light output from the left-eye display system 610L to an exit pupil 660. The exit pupil 660 may be a location where an eye pupil 655 of an eye 665 of the user is positioned in an eye-box region 630 of the left-eye display system 610L. In some embodiments, the lens system 685 may be configured to correct aberrations in the image light output from the left-eye display system 610L, magnify the image light output from the left-eye display system 610L, or perform another type of optical adjustment to the image light output from the left-eye display system 610L. The lens system 685 may include multiple optical elements, such as lenses, waveplates, reflectors, etc. In some embodiments, the lens system 685 may include a pancake lens assembly configured to fold the optical path, thereby reducing the back focal distance in the NED 600. The pancake lens assembly may be any embodiment of the pancake lens assemblies disclosed herein, such as the pancake lens assembly 501 shown in FIG. 5A. The object tracking system 650 may include an IR light source 651 configured to illuminate the eye 665 and/or the face, a deflecting element 652 configured to deflect the IR light reflected by the eye 665, and an optical sensor 653 configured to receive the IR light deflected by the deflecting element 652 and generate a tracking signal. In some embodiments, the object tracking system 650 may include one or more LC devices disclosed herein.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a first birefringent film including a calamitic liquid crystal (“LC”) material configured with a first helical structure; and
a second birefringent film stacked with the first birefringent film and including a discotic LC material configured with a second helical structure.

2. The device of claim 1, wherein at least one of the first birefringent film or the second birefringent film is a liquid crystal polymer film.

3. The device of claim 1, wherein both of the first helical structure and the second helical structure have a constant helix pitch.

4. The device of claim 1, wherein both of the first helical structure and the second helical structure have a varying helix pitch.

5. The device of claim 1, wherein one of the first helical structure and the second helical structure has a constant helix pitch, and the other one of first helical structure and the second helical structure has a varying helix pitch.

6. The device of claim 1, wherein
for an oblique incident light, the first birefringent film is configured to provide a first phase shift, and the second birefringent film is configured to provide a second phase shift, and
the first phase shift at least partially cancels out the second phase shift.

7. The device of claim 1, wherein the first helical structure and the second helical structure have the same handedness.

8. The device of claim 7, wherein
the handedness of the first helical structure and the second helical structure is a first handedness, and
a stack of the first birefringent film and the second birefringent film is configured to reflect a first circularly polarized light having the first handedness as a second circularly polarized light having the first handedness, and transmit a third circularly polarized light having a second handedness that is opposite to the first handedness as a fourth circularly polarized light having the second handedness.

9. A device, comprising:
an optical film including a birefringent medium having a chirality, the birefringent medium including a host material and dyes doped into the host material,
wherein the dyes are configured to absorb a first circularly polarized light having a predetermined handedness more than a second circularly polarized light having a handedness opposite to the predetermined handedness.

10. The device of claim 9, wherein molecules of the dyes have molecular helices with an induced axial chirality.

11. The device of claim 10, wherein the molecular helices of the molecules of the dyes rotate in a same rotating direction, along a same predetermined direction within a volume of the optical film.

12. The device of claim 9, wherein the dyes function as chiral dopants for introducing the chirality.

13. The device of claim 12, wherein molecules of the dyes form a plurality of supramolecules within a volume of the optical film, and molecular helices of the supramolecules rotate in a predetermined direction along an axial direction of the optical film.

14. The device of claim 9, wherein the optical film is configured to block, via absorption, the first circularly polarized light, and transmit or reflect the second circularly polarized light.

15. The device of claim 9, further comprising one or more electrodes coupled to the optical film, and configured to apply a voltage to the optical film to adjust a light transmittance of the optical film for the first circularly polarized light.

16. A lens assembly, comprising:
a first optical element including a mirror configured to transmit a first portion of a first circularly polarized light having a first handedness; and
a second optical element including a reflective polarizer configured to reflect the first portion of the first circularly polarized light as a second circularly polarized light having the first handedness back toward the mirror,
wherein the reflective polarizer includes a first birefringent film including a calamitic liquid crystal (“LC”) material, and a second birefringent film stacked with the first birefringent film and including a discotic LC material, and
wherein at least one of the first optical element or the second optical element includes a lens.

17. The lens assembly of claim 16, wherein
the mirror is further configured to reflect the second circularly polarized light having the first handedness as a third circularly polarized light having a second handedness, and
the reflective polarizer is further configured to transmit the third circularly polarized light having the second handedness as a fourth circularly polarized light having the second handedness.

18. The lens assembly of claim 16, wherein at least one of the first birefringent film or the second birefringent film is a liquid crystal polymer film.

19. The lens assembly of claim 16, wherein
the calamitic LC material is configured with a first helical structure,
the discotic LC material is configured with a second helical structure, and
at least one of the first helical structure or the second helical structure has a constant helix pitch or a varying helix pitch.

20. The lens assembly of claim 16, wherein
for an oblique incident light, the first birefringent film is configured to provide a first phase shift and the second birefringent film is configured to provide a second phase shift, and
the first phase shift at least partially cancels out the second phase shift.
